(19) United States
(12) Patent Application Publication
(10) Pub. No.: US 2024/0150519 A1
(43) Pub. Date: May 9, 2024

(54) HYDROXYL-FUNCTIONALIZED CARDO-BASED POLYIMIDE MEMBRANES

(71) Applicant: Saudi Arabian Oil Company, Dhahran (SA)

(72) Inventors: Ali Hayek, Dhahran (SA); Abdulkarim Alsamah, Dhahran (SA)

(21) Appl. No.: 17/970,260

(22) Filed: Oct. 20, 2022

(51) Int. Cl. C08G 61/12; B01D 71/62; C08G 61/10

(52) U.S. Cl. CPC C08G 61/124; B01D 71/62; C08G 61/10; B01D 2257/304; B01D 2257/504

(57) ABSTRACT

This disclosure relates to polymeric membranes that incorporate a hydroxyl-functionalized CARDO moiety that can be used in sour natural gas separation and purification applications.

### TECHNICAL FIELD

This document relates to copolyimides containing hydroxyl-functionalized CARDO and to membranes containing the copolyimides. This document also relates to methods of using the membranes for sour natural gas purification applications.

### BACKGROUND

It is often unpredictable to incorporate hydroxyl groups into a polymer backbone of a polymeric membrane. It has been shown that hydroxyl groups can form interchain hydrogen-bond interactions which brings the polymeric chains closer, and therefore reduces excess free volume, leading to a decrease in gas permeability of membranes used in gas purification applications. Thus, it is not easy to predict the outcome of incorporating hydroxyl groups into the polymer backbone. Moreover, it becomes even more challenging when dealing with gas mixtures containing hydrogen sulfide, because membranes are prone to plasticization due to the high affinity of H₂S molecules to polymeric materials due to the polar nature of H₂S molecules.

Membranes containing polymeric backbones functionalized with groups such as alkyl or acyl groups have been prepared; however, there is a typically a permeability-selectivity trade-off, and such membranes typically do not exhibit both favorable diffusivity and solubility properties. The current development of membranes suffers from poor permeation properties and/or plasticization resistance at elevated gas feed pressures, which limits their used in natural gas upgrading.

Accordingly, there is a need for a membrane that can be used for sour natural gas purification applications that simultaneously exhibits improved solubility and diffusivity of gas molecules through the membrane.

### SUMMARY

Provided in the present disclosure are polymers that contain a structural repeat unit of Formula (I):

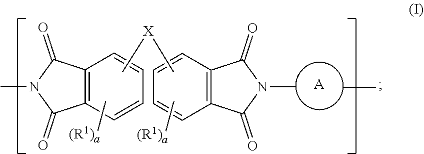

and
a structural repeat unit of Formula (II):

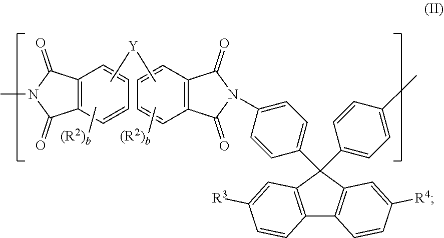

wherein:
A is absent or selected from phenylene, biphenylene, terphenylene, and polycyclic aromatic hydrocarbon, wherein the phenylene, biphenylene, terphenylene, and polycyclic aromatic hydrocarbon are each optionally substituted with one or more R⁵;
X and Y are each independently selected from a bond, —O—, —C(O)—, —O-phenyl-Z-phenyl-O—, and C₁₋₄ alkylene optionally substituted with one or more R⁶;
Z is C₁₋₄ alkylene optionally substituted with one or more R⁶;
each R¹ and R² is independently selected from halo and C₁₋₄ alkyl optionally substituted with one or more halo;
R³ and R⁴ are each independently selected from H, —OH, halo, C₁₋₆ alkyl, C₁₋₆ haloalkyl, phenyl, —C₁₋₄ alkyl-phenyl, and —NR^{a}R^{b}, wherein R^{a} and R^{b} are each independently selected from H and C₁₋₆ alkyl, and wherein at least one of R³ and R⁴ is —OH;
each R⁵ and R⁶ is independently selected from halo, —OH, —NH₂, —SH, —C(O)OH, —N₃, and C₁₋₄ alkyl optionally substituted with one or more R⁷, wherein each R⁷ is independently selected from halo, —OH, —NH₂, —SH, —C(O)OH, and —N₃; and
a and b are each independently 0, 1, 2, or 3;
wherein the polymer comprises the structural repeat unit of Formula (I) and the structural repeat unit of Formula (II) in a molar ratio of about 5:1 to about 1:5.

In some embodiments, A is phenylene optionally substituted with one, two, three, or four R⁵.

In some embodiments, each R⁵ is independently C₁₋₄ alkyl. In some embodiments, each R⁵ is methyl.

In some embodiments, X and Y are each C₁ alkylene, each optionally substituted with one or two R⁶. In some embodiments, each R⁶ is independently C₁ alkyl optionally substituted with one, two, or three R⁶, and each R⁶ is independently halo.

In some embodiments, X and Y are each C₁ alkylene, wherein each C₁ alkylene is substituted with two —CF₃.

In some embodiments, R³ and R⁴ are each independently selected from H, —OH, halo, C₁₋₄ alkyl, phenyl, —C₁₋₂ alkyl-phenyl, —NH₂, and —N(CH₃)₂, wherein at least one of R³ and R⁴ is —OH. In some embodiments, R³ is —OH and R⁴ is selected from H, —OH, halo, C₁₋₄ alkyl, phenyl, —C₁₋₂ alkyl-phenyl, —NH₂, and —N(CH₃)₂. In some embodiments, R³ and R⁴ are each —OH.

In some embodiments, a and b are each independently 0 or 1.

In some embodiments, the polymer contains the structural repeat unit of Formula (I) and the structural repeat unit of Formula (II) in a molar ratio of about 3:1 to about 1:3. In some embodiments, the polymer contains the structural repeat unit of Formula (I) and the structural repeat unit of Formula (II) in a molar ratio of about 2:1 to about 1:2. In some embodiments, the polymer contains the structural repeat unit of Formula (I) and the structural repeat unit of Formula (II) in a molar ratio of about 1:1.

In some embodiments, the polymer has a number-average molecular weight of about 1,000 g/mol to about 1,000,000 g/mol. In some embodiments, the polymer has a number-average molecular weight of about 100,000 g/mol to about 500,000 g/mol.

In some embodiments of the polymer, the structural repeat unit of Formula (I) is a structural repeat unit of Formula (I-B):

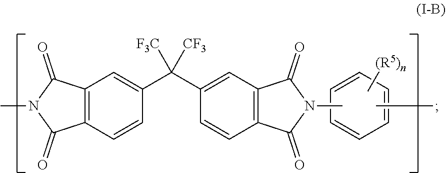

and
the structural repeat unit of Formula (II) is a structural repeat unit of Formula (II-B):

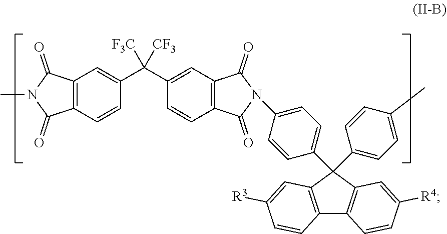

wherein:
R³ and R⁴ are each independently selected from H, —OH, halo, C₁₋₄ alkyl, phenyl, —C₁₋₂ alkyl-phenyl, —NH₂, and —N(CH₃)₂, wherein at least one of R³ and R⁴ is —OH;
each R⁵ is independently C₁₋₄ alkyl;
n is 0, 1, 2, 3, or 4; and
the polymer comprises the structural repeat unit of Formula (I-B) and the structural repeat unit of Formula (II-B) in a molar ratio of about 3:1 to about 1:3.

In some embodiments of Formula (II-B), R³ and R⁴ are each —OH.

In some embodiments of Formula (I-B), each R⁵ is methyl.

In some embodiments, n is 3 or 4.

In some embodiments, the polymer contains the structural repeat unit of Formula (I-B) and the structural repeat unit of Formula (II-B) in a molar ratio of about 2:1 to about 1:2. In some embodiments, the polymer contains the structural repeat unit of Formula (I-B) and the structural repeat unit of Formula (II-B) in a molar ratio of about 1:1.

Also provided in the present disclosure is a membrane that contains the polymer of Formula (I). In some embodiments, the membrane contains at least about 80 wt % of the polymer.

Also provided in the present disclosure is a method for separating CO₂ and H₂S from natural gas. In some embodiments, the method includes introducing a natural gas stream to the membrane of the present disclosure; and separating the CO₂ and the H₂S from the natural gas stream.

In some embodiments of the method, the natural gas stream contains about 1 vol % to about 30 vol % of CO₂ and about 1 vol % to about 40 wt % of H₂S, prior to separating the CO₂ and the H₂S from the natural gas stream.

### DESCRIPTION OF DRAWINGS

FIG. 1 is the ¹H NMR spectrum of 4,4′-(2,7-dibromo-9H-fluorene-9,9-diyl)dianiline [CARDO(OH)] in DMSO-d₆.

FIG. 2 is the FTIR spectrum of 4,4′-(2,7-dibromo-9H-fluorene-9,9-diyl)dianiline [CARDO(OH)] monomer.

FIG. 3 is the ¹H NMR spectrum of 6FDA-CARDO(OH) homopolymer in DMSO-d₆.

FIG. 4 is the ¹H NMR spectrum of 6FDA-durene/6FDA-CARDO(OH) (2:1) copolymer in DMSO-d₆.

FIG. 5 is the normalized FTIR spectra of the series of 6FDA-durene/6FDA-CARDO(OH) (x:1) copolyimide.

FIG. 6A depicts the thermogravimetric analysis (TGA) and the first derivative (DTG) curves and FIG. 6B shows the differential scanning calorimetric (DSC) traces of the prepared polymers.

FIG. 7 shows the CO₂/CH₄ permeability-selectivity “trade-off” curve as reported by Robeson.

FIG. 8 shows the change on the sweet mixed-gas CO₂ permeability (columns) and CO₂/CH₄ selectivity (curves) coefficients of CARDO(OH)-containing copolyimides at different feed pressures and 22° C.

FIG. 9 depicts a proposed self-crosslinking mechanism of hydroxyl-functionalized CARDO-based polymers.

### DETAILED DESCRIPTION

Provided in the present disclosure are polymeric membranes prepared from polyimides containing hydroxyl-functionalized 9,9-bis(4-aminophenyl)fluorene (CARDO) moieties for sour natural gas purification applications. Also provided in this disclosure are methods for preparing polyimide structures containing symmetric or asymmetric hydroxyl-functionalized CARDO moieties. One or two hydroxyl groups can be positioned in the 2 and/or 7 positions of the fluorenyl group of the CARDO moiety to serve as polar groups which can simultaneously improve the solubility and diffusivity of gas molecules through the polymeric matrix of membranes containing such moieties.

It has surprisingly been found that polymers such as CARDO that have been functionalized with hydroxyl groups tend to behave differently than what someone skilled in the art would predict. In some embodiments, the permeability coefficients of membranes containing such polymers increased. Without wishing to be bound by any particular theory, it is believed that the excess free volume within the membrane matrix is increased due to a particular special arrangement of hydroxyl groups, such as similar to what happens in ice. The dynamic free volume within the membrane matrix can separate the gas molecules based on the difference of their sizes (kinetic diameters, Dₖ) according to a kinetic phenomenon (rate of diffusion), since methane (Dₖ=3.80 Å, the main component of natural gas) is larger in size than the undesired existent impurities in natural gas (Dₖ=3.30 Å for CO₂ and Dₖ=3.60 Å for H₂S). Additionally, improving the gas-polymer affinity allows better solubility of polar gas molecules, such as H₂S, or molecules containing polar bonds, such as CO_{2,} to favor their permeation through the membrane matrix, while not influencing the transport of methane.

Thus, the presence of a hydroxyl group in the polymer backbone is beneficial since it enhances the polymer/polymer interactions and the gas/polymer affinity. In particular, it increases the gas/polymer affinity of polar gases such as hydrogen sulfide, or gases containing polar bonds such as carbon dioxide. Alkyl and alkoxy groups affect the interchain interactions through adding weaker interactions than hydrogen bond (which is the case for a hydroxyl group) and increasing the excess free volume through adding bulkiness to the polymeric chain.

The CARDO-based compounds of the present disclosure that are functionalized with one or more hydroxyl groups have increased van der Waals volume as compared to the same CARDO moiety without the hydroxyl groups. For example, adding a hydroxyl group to the CARDO structure increases its van der Waals volume [338.51 Å³ for 9,9-bis(4-aminophenyl)-9H-fluorene-2,7-diol and 321.61 Å³ for 9,9-bis(4-aminophenyl)fluorene]. Therefore, adding one or more hydroxyl groups to the polymer backbone allows for fine-tuning the diffusivity and solubility of gas molecules by increasing the dynamic free volume within the membrane matrix and the gas-polymer affinity, respectively.

Additionally, the hydroxyl groups also can enhance the possibility of thermal self-crosslinking (by allowing two adjacent phenol groups to react to form a covalent bond which serves as a crosslinker) at high temperatures, such as at temperatures greater than about 180° C.

Thus, provided in the present disclosure are polymeric membranes with improved performance for use in natural gas separation applications. Use of the membranes of the present disclosure allow for enhanced productivity, efficiency, and resistance to plasticization at elevated operational conditions of pressure and temperature during sweet and/or sour mixed-gas separation, which can reduce the capital expenditure (CAPEX) and operational expenditure (OPEX) of the membrane-based natural gas purification process.

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

### Definitions

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting. All publications, patent applications, patents, sequences, database entries, and other references mentioned in this document are incorporated by reference in their entirety. In case of conflict, the present specification, including definitions, will control.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The terms “sour” or “sour gas” mean that the gas stream contains hydrogen sulfide (H₂S).

As used in the present disclosure, the term “monomer unit,” used in reference to a polymer, refers to a monomer, or residue of a monomer, that has been incorporated into at least a portion of the polymer.

As used in the present disclosure, the term “polymerization product,” used in reference to one or more monomers, refers to a polymer that can be formed by a chemical reaction of the one or more monomers. For example, a “polymerization product” of acrylic acid is a polymer containing acrylic acid monomer units.

As used in the present disclosure, the term “Cₙ₋ₘ alkyl” refers to any linear or branched saturated hydrocarbon group having n to m carbons. Alkyl groups include, but are not limited to, methyl, ethyl, propyl such as propan-1-yl, propan-2-yl (iso-propyl), butyl such as butan-1-yl, butan-2-yl (sec-butyl), 2-methyl-propan-1-yl (iso-butyl), 2-methyl-propan-2-yl (t-butyl), pentyl, hexyl, octyl, dectyl, and the like. As used in the present disclosure, the term “alkylene” refers to a bivalent alkyl.

As used in the present disclosure, the term “polycyclic aromatic hydrocarbon” refers to any multiple-condensed ring system of two or more fused, all-carbon aromatic rings. Polycyclic aromatic hydrocarbons include, but are not limited to, naphthalene, anthracene, triphenylene, pyrene, perylene, and the like.

As used in the present disclosure, the term “halo” refers to —F, —Cl, —Br, or —I.

As used in the present disclosure, the term “hydroxyl” refers to —OH.

As used in the present disclosure, the term “amino” refers to —NH₂.

As used in the present disclosure, the term “thiol” refers to —SH.

As used in the present disclosure, the term “carboxyl” refers to —C(O)OH.

As used in the present disclosure, the term “azido” refers to —N₃.

Where a variable of the present disclosure defines a group having more than one substituent (for example, group A of Formula (I)) and the Markush group definition for that variable lists, for example, a polycyclic aromatic hydrocarbon, then it is understood that the polycyclic aromatic hydrocarbon represents a substituent having the necessary valency.

### Polymers

The polymers of the present disclosure contain hydroxyl-functionalized CARDO moieties. In some embodiments, the CARDO moiety is functionalized with a hydroxyl moiety at the 2 position, the 7 position, or both. Scheme 1 depicts an exemplary synthetic scheme of a hydroxyl-functionalized CARDO moiety of the present disclosure As shown in Scheme 1, the hydroxyl-functionalized CARDO moiety could be symmetric or asymmetric in a way such that the substituents X¹ and X₂ are the same or different. In some embodiments, X¹=X²=—OH. In some embodiments, X¹≠X², where one of X¹ or X² is a hydroxyl group (—OH), and the second is a different atom (for example, hydrogen or halogen) or group (for example, alkyl, aryl, amine derivative).

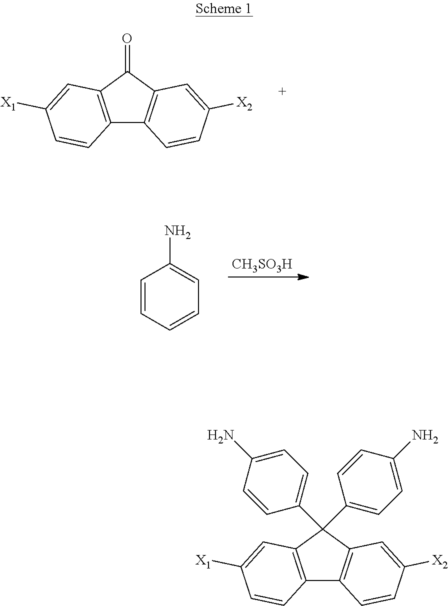

Exemplary symmetric and asymmetric hydroxyl-functionalized CARDO diamine monomers that can be prepared and used in the polymers and membranes of the present disclosure include, but are not limited to:

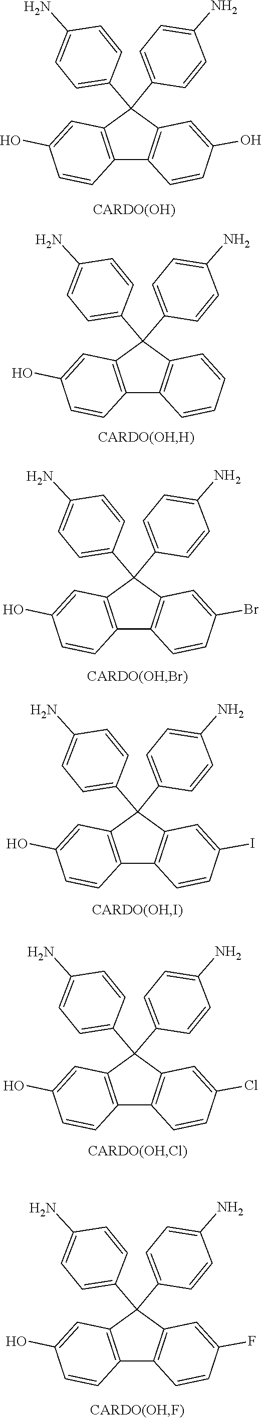

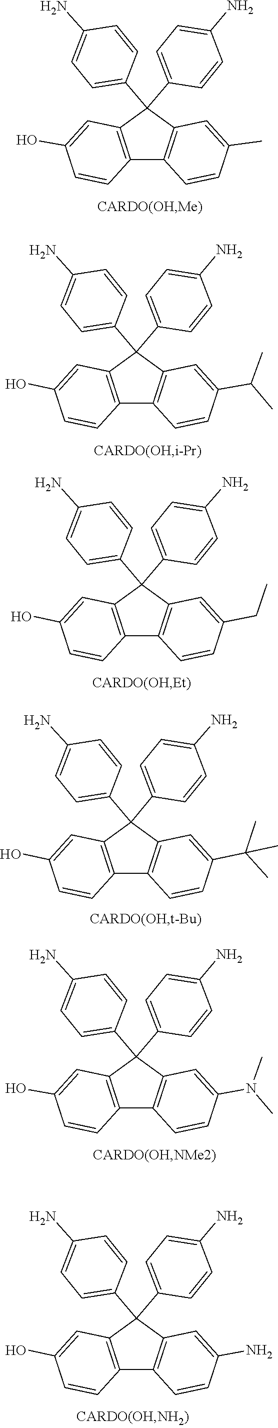 [SMILES: Cc1ccc2c(c1)C(c1ccc(N)cc1)(c1ccc(N)cc1)c1cc(O)ccc1-2 ; CC(C)c1ccc2c(c1)C(c1ccc(N)cc1)(c1ccc(N)cc1)c1cc(O)ccc1-2 ; CCc1ccc2c(c1)C(c1ccc(N)cc1)(c1ccc(N)cc1)c1cc(O)ccc1-2 ; CC(C)(C)c1ccc2c(c1)C(c1ccc(N)cc1)(c1ccc(N)cc1)c1cc(O)ccc1-2 ; CN(C)c1ccc2c(c1)C(c1ccc(N)cc1)(c1ccc(N)cc1)c1cc(O)ccc1-2 ; Nc1ccc(C2(c3ccc(N)cc3)c3cc(N)ccc3-c3ccc(O)cc32)cc1]

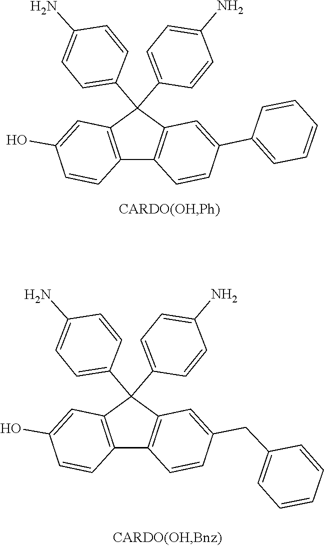 [SMILES: Nc1ccc(C2(c3ccc(N)cc3)c3cc(O)ccc3-c3ccc(-c4ccccc4)cc32)cc1 ; Nc1ccc(C2(c3ccc(N)cc3)c3cc(O)ccc3-c3ccc(Cc4ccccc4)cc32)cc1]

The prepared hydroxyl-functionalized CARDO diamine monomers can be reacted with a variety of dianhydride monomers to afford homopolyimides (Scheme 2) and a variety of dianhydride and other aromatic diamine monomers to afford copolyimides (Scheme 3), where Ar₁ and Ar₂ represent the various aromatic moieties that can be used in the preparation of the hydroxyl-functionalized CARDO-based homopolyimides and copolyimides of the present disclosure. The homopolyimides are prepared using a hydroxyl-functionalized CARDO moiety and a dianhydride monomer while the copolyimides are prepared using a hydroxyl-functionalized CARDO moiety and a dianhydride monomer in addition to another diamine monomer. The copolymerization aims to combine the gas permeation properties of two separate homopolymers into one copolymer structure. The homopolyimides and copolyimides can be used to prepare polymeric membranes with improved sweet and/or sour mixed-gas separation properties for natural gas purification applications. In some embodiments, the second diamine monomer is chosen to complement the properties provided by the hydroxyl-functionalized CARDO-based homopolyimide to either improve the permeability or selectivity of the copolyimide membrane.

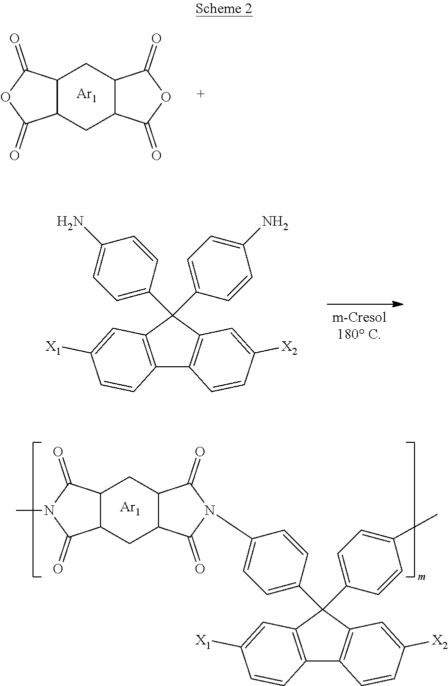

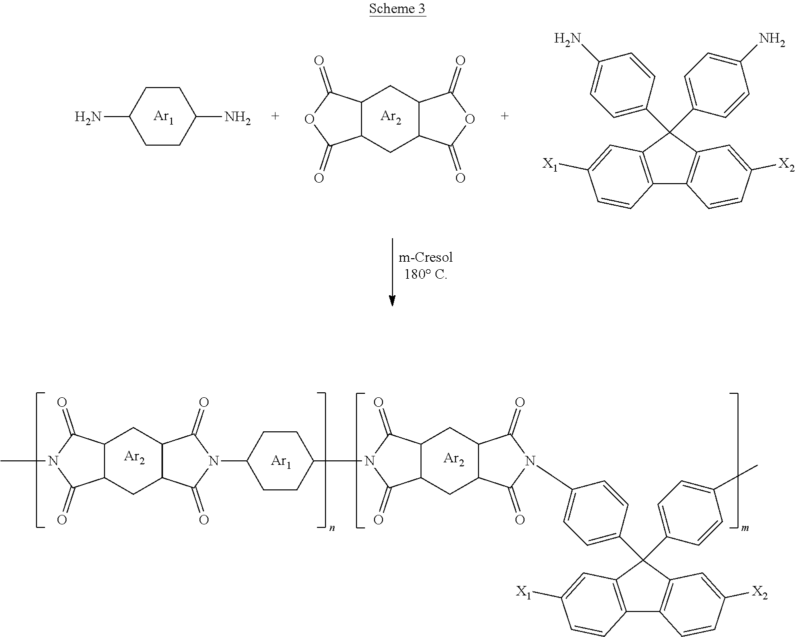

Exemplary dianhydride monomers that can be used in the polymers and membranes of the present application include, but are not limited to:

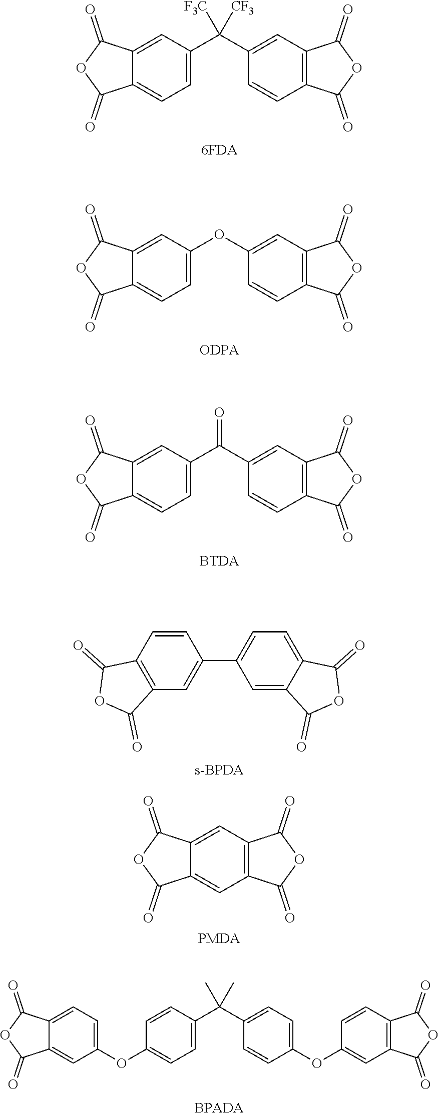

The aromatic diamine monomer used in the preparation of the copolyimides of the present disclosure can be used to provide polymer segments that can tailor the properties of the targeted polymeric materials. Exemplary diamine monomers that can be used in the polymers and membranes of the present application include, but are not limited to:

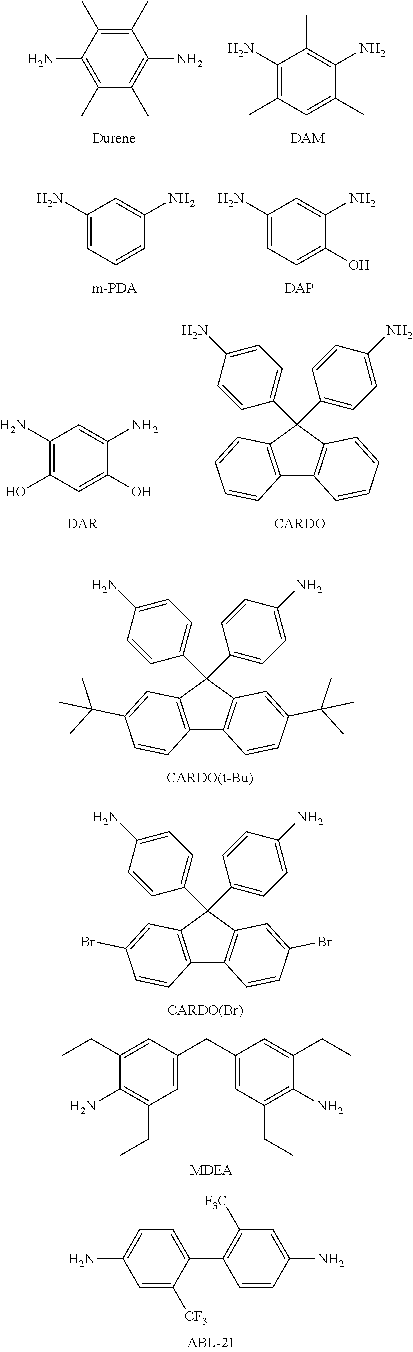

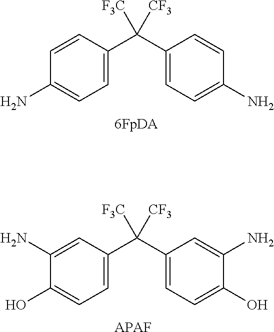

Thus, provided in the present disclosure are polymers that contain a structural repeat unit of Formula (I):

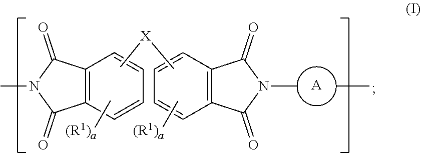

and
a structural repeat unit of Formula (II):

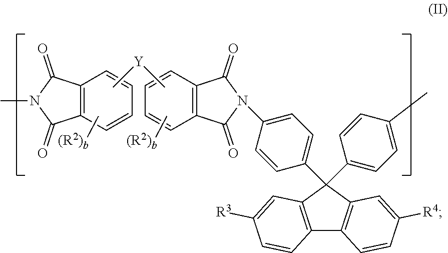

wherein:
A is absent or selected from phenylene, biphenylene, terphenylene, and polycyclic aromatic hydrocarbon, wherein the phenylene, biphenylene, terphenylene, and polycyclic aromatic hydrocarbon are each optionally substituted with one or more R⁵;

X and Y are each independently selected from a bond, —O—, —C(O)—, —O-phenyl-Z-phenyl-O—, and C₁₋₄ alkylene optionally substituted with one or more R⁶;
Z is C₁₋₄ alkylene optionally substituted with one or more R⁶;
each R¹ and R² is independently selected from halo and C₁₋₄ alkyl optionally substituted with one or more halo;
R³ and R⁴ are each independently selected from H, —OH, halo, C₁₋₆ alkyl, C₁₋₆ haloalkyl, phenyl, —C₁₋₄ alkyl-phenyl, and —NR^{a}R^{b}, wherein R^{a} and R^{b} are each independently selected from H and C₁₋₆ alkyl, and wherein at least one of R³ and R⁴ is —OH;

each R⁵ and R⁶ is independently selected from halo, —OH, —NH₂, —SH, —C(O)OH, —N₃, and C₁₋₄ alkyl optionally substituted with one or more R⁷, wherein each R⁷ is independently selected from halo, —OH, —NH₂, —SH, —C(O)OH, and —N₃; and
a and b are each independently 0, 1, 2, or 3.
In some embodiments, X and Y are the same. In some embodiments, each R¹ and R² are the same.

In some embodiments, the structural repeat unit of Formula (I) and the structural repeat unit of Formula (II) make up at least about 80 wt % of the polymer. In some embodiments, the structural repeat unit of Formula (I) and the structural repeat unit of Formula (II) make up at least about 85 wt %, at least about 90 wt %, at least about 95 wt %, at least about 97.5 wt %, at least about 98 wt %, at least about 98.5 wt %, or at least about 99 wt % of the polymer.

In some embodiments, the structural repeat unit of Formula (I) and the structural repeat unit of Formula (II) are present in the polymer in a molar ratio of about 5:1 to about 1:5. In some embodiments, the structural repeat unit of Formula (I) and the structural repeat unit of Formula (II) are present in the polymer in a molar ratio of about 5:1 to about 1:4, about 5:1 to about 1:3, about 5:1 to about 1:2, about 4:1 to about 1:5, about 4:1 to about 1:4, about 4:1 to about 1:3, about 4:1 to about 1:2, about 3:1 to about 1:5, about 3:1 to about 1:4, about 3:1 to about 1:3, about 3:1 to about 1:2, about 2:1 to about 1:5, about 2:1 to about 1:4, about 2:1 to about 1:3, or about 2:1 to about 1:2. In some embodiments, the structural repeat unit of Formula (I) and the structural repeat unit of Formula (II) are present in the polymer in a molar ratio of about 3:1. In some embodiments, the structural repeat unit of Formula (I) and the structural repeat unit of Formula (II) are present in the polymer in a molar ratio of about 2:1. In some embodiments, the structural repeat unit of Formula (I) and the structural repeat unit of Formula (II) are present in the polymer in a molar ratio of about 1:1.

In some embodiments, the polymer has a number-average molecular weight of about 1,000 g/mol to about 1,000,000 g/mol, such as about 1,000 g/mol to about 900,000 g/mol, about 10,000 g/mol to about 800,000 g/mol, about 50,000 g/mol to about 700,000 g/mol, about 100,000 g/mol to about 600,000 g/mol, about 200,000 g/mol to about 500,000 g/mol, about 300,000 g/mol, or about 1,000 g/mol, about 5,000 g/mol, about 10,000 g/mol, about 25,000 g/mol, about 50,000 g/mol, about 100,000 g/mol, about 150,000 g/mol, about 200,000 g/mol, about 250,000 g/mol, about 300,000 g/mol, about 350,000 g/mol, about 400,000 g/mol, about 450,000 g/mol, about 500,000 g/mol, about 550,000 g/mol, about 600,000 g/mol, about 650,000 g/mol, about 700,000 g/mol, about 750,000 g/mol, about 800,000 g/mol, about 850,000 g/mol, about 900,000 g/mol, about 950,000 g/mol, or about 1,000,000 g/mol.

The polymers of the present disclosure can be prepared according to any suitable method. For example, polymers including a structural repeat unit of Formula (I) and a structural repeat unit of Formula (II) can be prepared by polycondensation of a dianhydride monomer, a hydroxyl-functionalized CARDO monomer, and an aromatic diamino monomer. In some embodiments, the polymer includes the polymerization product of a diphthalic anhydride monomer (for example, 5,5′-(perfluoropropane-2,2-diyl)bis(isobenzofuran-1,3-dione), a hydroxyl-functionalized CARDO monomer (for example, CARDO(OH)), and an aromatic diamino monomer (for example, 2,3,5,6-tetramethylbenzene-1,4-diamine (durene) or 2,4,6-trimethylbenzene-1,3-diamine (DAM)).

The synthetic methodology described in the present disclosure allows for the preparation of a large variety of hydroxyl-functionalized CARDO-based polymers, including, but not limited to, homopolymers, random copolymers, block copolymers, terpolymers, alternating copolymers, and so on.

### Formula (I)

In some embodiments, A is phenylene, biphenylene, terphenylene, naphthalenylene, or anthracenylene. In some embodiments, A is phenylene. In some embodiments, A is optionally substituted with one, two, three, or four R⁵. In some embodiments, A is substituted with two or three R⁵. In some embodiments, A is phenylene substituted with three R⁵. In some embodiments, at least one R⁵ is independently C₁₋₄ alkyl. In some embodiments, each R⁵ independently C₁₋₄ alkyl. In some embodiments, each R⁵ is unsubstituted C₁₋₄ alkyl. For example, in some embodiments, each R⁵ is unsubstituted C₁ alkyl. In some embodiments, A has the structure:

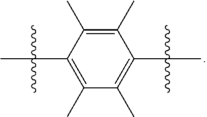 [SMILES: *c1c(C)c(C)c(*)c(C)c1C]

In some embodiments, A has the structure:

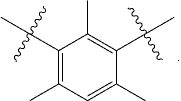 [SMILES: *c1c(C)cc(C)c(*)c1C]

In some embodiments, X is selected from a bond, —O—, —C(O)—, —O-phenyl-Z-phenyl-O—, and C₁₋₄ alkylene optionally substituted with one or more R⁶.

In some embodiments, X is a bond.

In some embodiments, X is —O—.

In some embodiments, X is —C(O)—.

In some embodiments, X is —O-phenyl-Z-phenyl-O—. In some embodiments, Z is C₁₋₄ alkylene optionally substituted with one or more R⁶. In some embodiments, Z is C₁₋₃ alkylene optionally substituted with one or more R⁶. In some embodiments, Z is C₁₋₂ alkylene optionally substituted with one or more R⁶. In some embodiments, Z is C₁ alkylene optionally substituted with one or more R⁶.

In some embodiments, X is C₁₋₄ alkylene optionally substituted with one or more R⁶. In some embodiments, X is C₁₋₃ alkylene optionally substituted with one or more R⁶. In some embodiments, X is C₁₋₂ alkylene optionally substituted with one or more R⁶. In some embodiments, X is C₁ alkylene optionally substituted with one or more R⁶.

In some embodiments, each R⁶ is independently selected from halo, —OH, —NH₂, —SH, —C(O)OH, —N₃, and C₁₋₄ alkyl optionally substituted with one or more R⁷, wherein each R⁷ is independently selected from halo, —OH, —NH₂, —SH, —C(O)OH, and —N₃. In some embodiments, each R⁶ is independently selected from C₁₋₄ alkyl optionally substituted with one or more R⁷. In some embodiments, R7 is halo. In some embodiments, X is C₁ alkylene substituted with two —CF₃. In some embodiments, X is —O-phenyl-Z-phenyl-O—, where Z is Z is C₁ alkylene substituted with two —CH₃.

In some embodiments, X is C₁ alkylene. In some embodiments, X is optionally substituted with one or two R⁶. For example, in some embodiments, X is substituted with one or two R⁶. In some embodiments of Formula (I), one or more R⁶ are each independently C₁ alkyl optionally substituted with one, two, or three halo. In some embodiments of Formula (I), each R⁶ is independently C₁ alkyl optionally substituted with one, two, or three halo. In some embodiments of Formula (I), each R⁶ is independently C₁ alkyl substituted with three halo. In some embodiments, one or more halo are —F. In some embodiments each halo is —F.

In some embodiments, each a is independently 0 or 1. In some embodiments, each a is 0.

In some embodiments, the structural repeat unit of Formula (I) is a structural repeat unit of Formula (I-A):

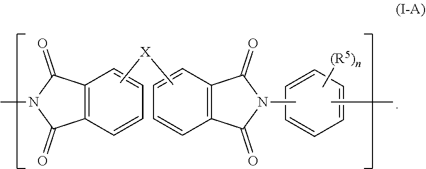

In some embodiments, n is 0, 1, 2, 3, or 4. On some embodiments, n is 0. In some embodiments, n is 1. In some embodiments, n is 2. In some embodiments, n is 3. In some embodiments, n is 4.

In certain embodiments of Formula (I-A), X is the same as Y of Formula (II) or Formula (II-A) of the present disclosure. In some embodiments of Formula (I-A), X is C₁ alkylene substituted with one or two R⁶. In some embodiments, Formula (I-A) includes three or four R⁵ groups. In certain embodiments of Formula (I-A), each R⁵ is independently unsubstituted C₁₋₄ alkyl, and each R⁶ is independently C₁₋₄ alkyl substituted with three halo.

In some embodiments, the structural repeat unit of Formula (I) is a structural repeat unit of Formula (I-B):

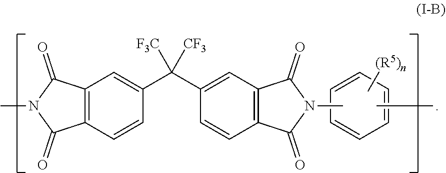

In some embodiments, n is 0, 1, 2, 3, or 4. On some embodiments, n is 0. In some embodiments, n is 1. In some embodiments, n is 2. In some embodiments, n is 3. In some embodiments, n is 4.

In some embodiments of Formula (I-B), each R⁵ is independently unsubstituted C₁₋₄ alkyl. In certain such embodiments, each R⁵ is unsubstituted C₁ alkyl. In some embodiments, Formula (I-B) includes three or four R⁵ groups.

### Formula (II)

In some embodiments, Y is selected from a bond, —O—, —C(O)—, —O-phenyl-Z-phenyl-O—, and C₁₋₄ alkylene optionally substituted with one or more R⁶.

In some embodiments, Y is a bond.

In some embodiments, Y is —O—.

In some embodiments, Y is —C(O)—.

In some embodiments, Y is —O-phenyl-Z-phenyl-O—. In some embodiments, Z is C₁₋₄ alkylene optionally substituted with one or more R⁶. In some embodiments, Z is C₁₋₃ alkylene optionally substituted with one or more R⁶. In some embodiments, Z is C₁₋₂ alkylene optionally substituted with one or more R⁶. In some embodiments, Z is C₁ alkylene optionally substituted with one or more R⁶.

In some embodiments, Y is C₁₋₄ alkylene optionally substituted with one or more R⁶. In some embodiments, Y is C₁₋₃ alkylene optionally substituted with one or more R⁶. In some embodiments, Y is C₁₋₂ alkylene optionally substituted with one or more R⁶. In some embodiments, Y is C₁ alkylene optionally substituted with one or more R⁶.

In some embodiments, each R⁶ is independently selected from halo, —OH, —NH₂, —SH, —C(O)OH, —N₃, and C₁₋₄ alkyl optionally substituted with one or more R⁷, wherein each R⁷ is independently selected from halo, —OH, —NH₂, —SH, —C(O)OH, and —N₃. In some embodiments, each R⁶ is independently selected from C₁₋₄ alkyl optionally substituted with one or more R⁷. In some embodiments, R⁷ is halo. In some embodiments, Y is C₁ alkylene substituted with two —CF₃. In some embodiments, Y is —O-phenyl-Z-phenyl-O—, where Z is C₁ alkylene substituted with two —CH₃.

In some embodiments, Y is C₁ alkylene. In some embodiments, Y is optionally substituted with one or two R⁶. For example, in some embodiments, Y is substituted with one or two R⁶. In some embodiments of Formula (I), one or more R⁶ are each independently C₁ alkyl optionally substituted with one, two, or three halo. In some embodiments of Formula (I), each R⁶ is independently C₁ alkyl optionally substituted with one, two, or three halo. In some embodiments of Formula (I), each R⁶ is independently C₁ alkyl substituted with three halo. In some embodiments, one or more halo are —F. In some embodiments each halo is —F.

In some embodiments, at least one of R³ and R⁴ is —OH. In some embodiments, R³ and R⁴ are each independently selected from H, —OH, halo, C₁₋₆ alkyl, C₁₋₆ haloalkyl, phenyl, —C₁₋₄ alkyl-phenyl, and —NR^{a}R^{b}, wherein R^{a} and R^{b} are each independently selected from H and C₁₋₆ alkyl. In some embodiments, one of R³ and R⁴ is —OH, and the other is selected from —H, —OH, —F, —Cl, —Br, —I, C₁₋₄ alkyl, —NH₂, —N(CH₃)₂, phenyl, and —CH₂-phenyl. In some embodiments, R³ and R⁴ are each —OH.

In some embodiments, each b is independently 0 or 1. In some embodiments, each b is 0.

In some embodiments, the structural repeat unit of Formula (II) is a structural repeat unit of Formula (II-A):

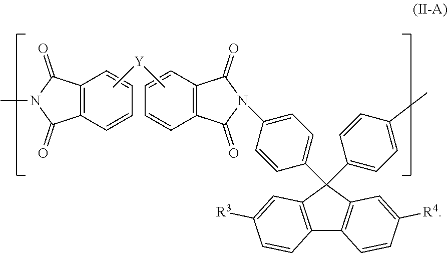

In certain embodiments of Formula (II-A), Y is the same as X of Formula (I) or Formula (I-A) of the present disclosure. In some embodiments of Formula (II-A), Y is C₁ alkylene substituted with one or two R⁶. In some embodiments, Formula (II-A) includes three or four R⁵ groups. In certain embodiments of Formula (II-A), each R⁵ is independently unsubstituted C₁₋₄ alkyl, and each R⁶ is independently C₁₋₄ alkyl substituted with three halo.

In some embodiments, the structural repeat unit of Formula (II) is a structural repeat unit of Formula (II-B):

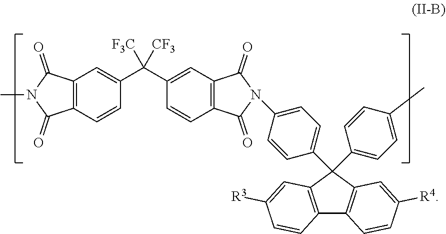

### Membranes

Also provided in the present disclosure are membranes including a polymer including a structural repeat unit of Formula (I) and a structural repeat unit of Formula (II). In some embodiments, the membrane includes any polymer of the present disclosure.

In some embodiments, the membrane includes at least about 80 wt % of the polymer. For example, in some embodiments, the membrane includes at least about 85 wt %, at least about 90 wt %, at least about 95 wt %, at least about 97.5 wt %, at least about 98 wt %, at least about 98.5 wt %, or at least about 99 wt % of the polymer.

### Methods for Preparing Membranes

Also provided in the present disclosure are methods for preparing a membrane of the present disclosure. Polymeric membranes are thin semipermeable barriers that selectively separate some gas compounds from others. The membranes are dense films that do not operate as a filter, but rather separate gas compounds based on how well the different compounds dissolve into the membrane and diffuse through it (the solution-diffusion model). The membranes of the present disclosure are useful for any gas separation application, including, but not limited to, natural gas sweetening, oxygen enrichment, hydrogen purification, and nitrogen and organic compounds removal from natural gas. In some embodiments, the membranes of the present disclosure are used for the separation of CO₂ and H₂S from sour gas.

In some embodiments, the method includes preparing a solution of any polymer of the present disclosure. In some embodiments, the polymer is added to a solvent and dissolved. In some embodiments, the solvent is an organic solvent. In some embodiments, the solvent is dimethylformamide (DMF). In some embodiments, the polymer is dissolved at room temperature. In some embodiments, the polymer is dissolved completely in the solvent before proceeding to the next step. In some embodiments, the polymer is filtered. In some embodiments, the polymer is filtered with a PTFE filter.

In some embodiments, the solution contains about 1 wt % to about 10 wt % polymer, such as about 2 wt % to about 5 wt %, or about 3 wt % polymer. In some embodiments, the solution containing the polymer is poured into a flat-bottomed container in order to prepare a film. In some embodiments, the film is dried to allow for evaporation of solvent. In some embodiments, the film is dried at an elevated temperature under a flow of nitrogen gas. In some embodiments, the film is further dried in a vacuum oven, for example, at about 100° C. to about 275° C., or about 150° C. to about 200° C. for at least about 4 hours, about 6 hours, about 12 hours, about 18 hours, about 24 hours, about 30 hours, about 36 hours, about 42 hours, about 48 hours, or more.

In some embodiments, after drying, the film is soaked in a second solvent. In certain such embodiments, the second solvent is deionized water. In some embodiments, the film is soaked in the second solvent for at least a few minutes or more. In some embodiments, the second solvent is removed from the film, and then the film is dried to provide the membrane. In some embodiments, the second solvent is removed from the film, and then the film is dried in a vacuum oven, for example, at about 60° C. for about 6 hours.

Also provided in the present disclosure are membranes prepared by the methods of the present disclosure. In general, for natural gas purification, it is desired to improve the permeability of impurities (such as carbon dioxide (CO₂) and hydrogen sulfide (H₂S)) and the membrane selectivities (CO₂/CH₄ and H₂S/CH₄) toward the main hydrocarbons constituting the natural gas (methane (CH₄)). In another aspect, it is desired to increase the plasticization resistance of polymeric membranes during high pressure mixed-gas separation. In some embodiments, the polar hydroxyl groups of the hydroxyl-functionalized CARDO groups form a hydrogen bond or dipole-dipole type interaction between the polymeric chains which limits their mobility under harsh separation conditions of temperature and pressure. Moreover, in some embodiments, the hydroxyl groups allow two adjacent phenol groups to react to form a covalent bond under high temperature (>180° C.) which will serve as a crosslinker, referred to in the present disclosure as thermal self-crosslinking. This strategy has proven to improve the permeation properties and plasticization resistance of the polymeric membranes during mixed-gas separation at high feed pressures.

In some embodiments, the membranes of the present disclosure demonstrate improved gas transport properties in natural gas separation, for example, sour gas separation, as compared to conventional polymer-based membranes that do not contain a hydroxyl-modified CARDO moiety. In some embodiments, the membranes of the present disclosure demonstrate high CO₂/CH₄ selectivity, high H₂S/CH₄ selectivity, and resistance to plasticization, for example, at a feed pressure up to about 900 psi, as compared to conventional polyimide-based membranes that do not contain a hydroxyl-modified CARDO moiety. The membranes of the present disclosure possess increased CO₂ permeation coefficients and comparable CO₂/CH₄ selectivity as compared to convention polyimide-based membranes that do not contain a hydroxyl-modified CARDO moiety.

### Methods of Using the Membranes

Current natural gas purification technology involves the use of liquid amines to remove acid gases from natural gas reserves. The use of liquid amines includes a liquid amine regeneration step which requires the consumption of a substantial amount of energy; a step that renders the process costly. The gas separation membranes of the present disclosure provide an alternative energy efficient method. The membranes of the present disclosure possess a set of specifications related to their gas permeability (or permeance) (H₂S and CO₂) and selectivity (CO₂/CH₄ and H₂S/CH₄) that allow this technology to compete or be conjugated with current technology. In some embodiments, the membranes exhibit mixed sour gas selectivity for CO₂/CH₄ and H₂S/CH₄ from 15 up to 25 and permeance up to 80 GPU for CO₂ and H₂S. Thus, the membranes of the present disclosure can be used in a bulk acid gas removal process. In some embodiments, the hydroxyl-functionalized CARDO-based polyimides provide for an improved membrane system for sweet and sour mixed-gas separation.

Thus, also provided in the present disclosure are methods for using a membrane of the present disclosure. In some embodiments, the methods include separating CO₂, H₂S, or both from natural gas by introducing a natural gas stream to any membrane of the present disclosure, and separating the CO₂, H₂S, or both from the natural gas stream. In some embodiments, the natural gas stream includes about 1 vol % to about 30 vol % of CO₂ before separating. For example, in some embodiments, the natural gas stream includes about 1 vol % to about 20 vol %, about 1 vol % to about 15 vol %, about 3 vol % to about 30 vol %, about 3 vol % to about 20 vol %, or about 3 vol % to about 15 vol % of CO₂ before separating. In some embodiments, the natural gas stream includes about 1 vol % to about 40 vol % of H₂S before separating. For example, in some embodiments, the natural gas stream includes about 1 vol % to about 30 vol %, about 1 vol % to about 25 vol %, about 5 vol % to about 40 vol %, about 5 vol % to about 30 vol %, or about 5 vol % to about 25 vol % of H₂S before separating.

In some embodiments, the natural gas stream includes at least about 30 vol %, for example, at least about 40 vol %, or at least about 50 vol % of CH₄ before separating. In some embodiments, the natural gas stream further includes N₂, C₂H₆, or both.

### EXAMPLES

### Example 1—Preparation of 9,9-bis(4-aminophenyl)-9H-fluorene-2,7-diol [CARDO(OH)]

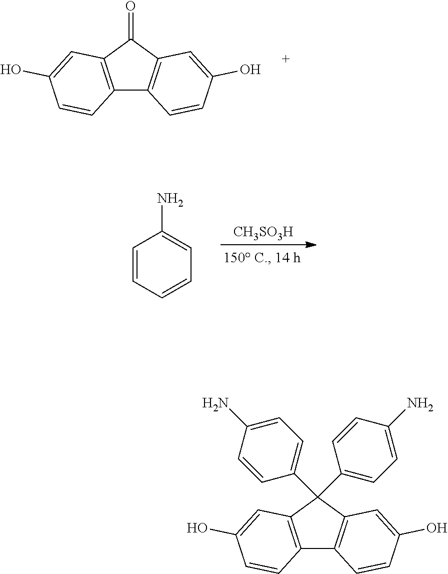

To a 500 mL three-neck round bottom flask equipped with a nitrogen inlet, condenser, and a magnetic bar, 2,7-dihydroxy-9H-fluoren-9-one (10.6 g, 50.0 mmol), aniline (36.4 mL, 400 mmol), and methanesulfonic acid (1.621 mL, 24.98 mmol) were added and the mixture was heated to 150° C. for 14 hours. The reaction mixture was then cooled down to room temperature and poured into a solution of 2.0 M sodium hydroxide in 200 mL of ethanol and stirred at the same temperature overnight. The precipitated solid was collected by filtration and washed thoroughly by ethanol and distilled water several times, then dried under vacuum overnight to provide 9,9-bis(4-aminophenyl)-9H-fluorene-2,7-diol (14.00 g, 36.8 mmol, 73.7% yield) as a pale-yellow solid. ¹H NMR (500 MHz, DMSO-d₆) δ 9.28 (s, 2H), 7.45 (d, J=7.7 Hz, 2H), 6.80-6.51 (m, 8H), 6.42 (d, J=7.5 Hz, 4H), 4.90 (s, 4H).

### Example 2—Preparation of Homopolymer 6FDA-CARDO(OH)

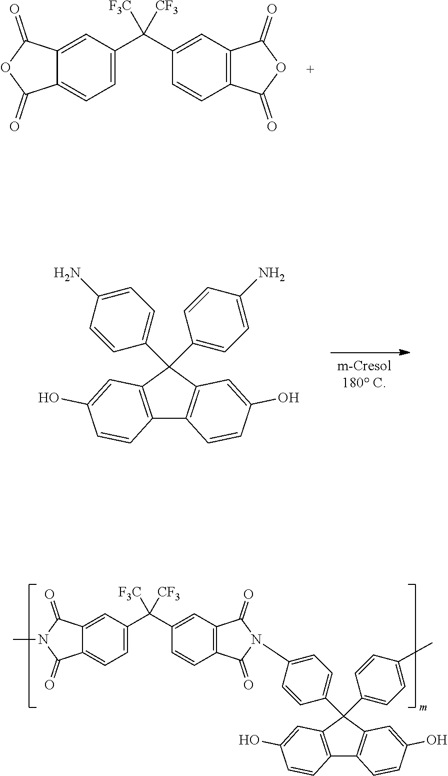

In a 100 mL three-neck round bottom flask equipped with a nitrogen inlet and a mechanical stirrer, 9,9-bis(4-aminophenyl)-9H-fluorene-2,7-diol (0.798 g, 2.098 mmol) [CARDO(OH)] and 5,5′-(perfluoropropane-2,2-diyl)bis(isobenzofuran-1,3-dione) (0.932 g, 2.098 mmol) (6FDA) were dissolved in m-cresol (8.00 mL). A catalytic amount (4 drops) of isoquinoline was added to the reaction mixture, and the mixture was then heated gradually to 180° C. and kept for 8 hours. The heat was removed, and the reaction mixture was allowed to cool down to room temperature. The resulting viscous solution was poured into methanol (30 mL), then washed three times (3×30 mL) to remove the residual m-cresol solvent. The final product 6FDA-CARDO(OH) (1.631 g, 1.993 mmol, 95% yield) was dried in an oven pre-set to 75° C. for 24 hours. ¹H NMR (500 MHz, DMSO-d₆) δ 9.26 (s, 2H), 8.12 (d, J=7.5 Hz, 2H), 7.93 (s, 2H), 7.78 (s, 2H), 7.57 (d, J=7.8 Hz, 2H), 7.40 (d, J=7.6 Hz, 4H), 7.29 (d, J=7.6 Hz, 4H), 6.84 (s, 2H), 6.79 (d, J=7.6 Hz, 2H).

### Example 3—Preparation of Block Copolyimide 6FDA-Durene/6FDA-CARDO(OH) (1:1)

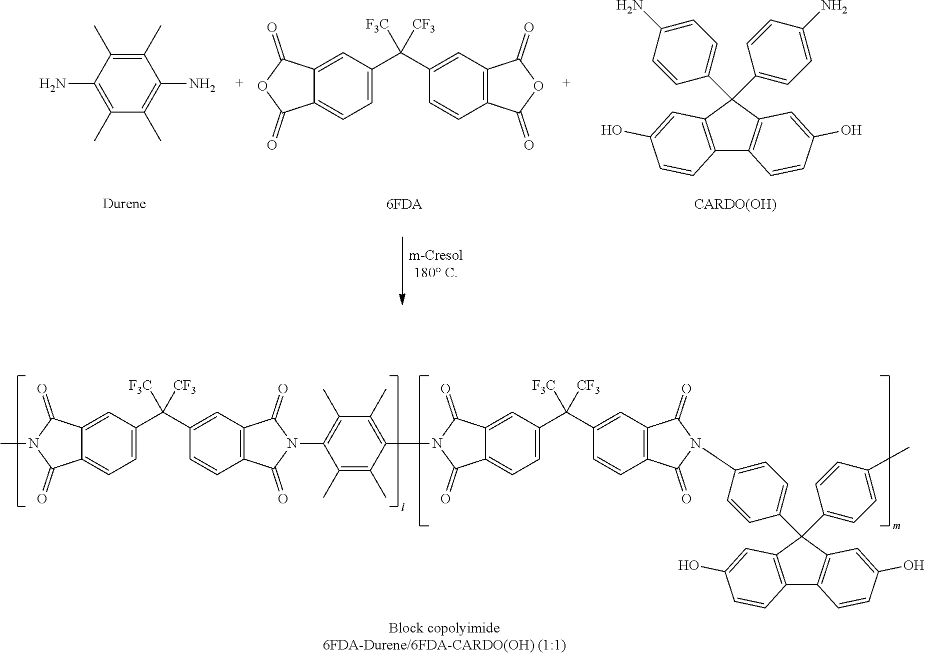

In a 100 mL three-neck round bottom flask equipped with a nitrogen inlet and a magnetic stir bar, 5,5′-(perfluoropropane-2,2-diyl)bis(isobenzofuran-1,3-dione) (0.574 g, 1.293 mmol) (6FDA) and 2,3,5,6-tetramethylbenzene-1,4-diamine (0.250 g, 1.522 mmol) (durene) were introduced and dissolved in m-cresol (12.0 mL) and the reaction mixture was heated to 180° C. and stirred for 8 hours. The heat was stopped overnight and the reaction was allowed to cool down to room temperature. The reaction mixture was preheated to 160° C., then 5,5′-(perfluoropropane-2,2-diyl)bis(isobenzofuran-1,3-dione) (0.778 g, 1.751 mmol) (6FDA) and 9,9-bis(4-aminophenyl)-9H-fluorene-2,7-diol (0.579 g, 1.522 mmol) [CARDO(OH)] were added, followed by m-cresol (12.00 mL) and the mixture was heated to 180° C. and stirred for 8 hours. The heat was removed and the reaction mixture was allowed to cool down below 100° C., then the resulting highly viscous solution was poured into methanol in thin fibers. The fibrous polymer obtained was ground, rinsed with methanol, filtered, and dried under reduced pressure for 24 h at 60° C. to afford 6FDA-durene/6FDA-CARDO(OH) (1:1) (2.075 g, 1.492 mmol, 98% yield) as an off-white powder. ¹H NMR (500 MHz, DMSO-d₆) δ 9.24 (s, 2H), 8.27-8.08 (m, 4H), 8.12-7.83 (m, 8H), 7.78 (s, 2H), 7.57 (d, J=7.2 Hz, 2H), 7.47-7.18 (m, 8H), 6.92-6.75 (m, 4H), 2.09 (s, 12H).

### Example 4—Preparation of Block Copolyimide 6FDA-Durene/6FDA-CARDO(OH) (2:1)

The same procedure as described in Example 3 was followed, using 5,5′-(perfluoropropane-2,2-diyl)bis(isobenzofuran-1,3-dione) (0.574 g, 1.293 mmol) (6FDA), 2,3,5,6-tetramethylbenzene-1,4-diamine (0.250 g, 1.522 mmol) (durene), and m-cresol (12.0 mL), then 5,5′-(perfluoropropane-2,2-diyl)bis(isobenzofuran-1,3-dione) (0.439 g, 0.989 mmol) (6FDA), and 9,9-bis(4-aminophenyl)-9H-fluorene-2,7-diol (0.290 g, 0.761 mmol) [CARDO(OH)], followed by m-cresol (12.00 mL) to afford 6FDA-durene/6FDA-CARDO(OH) (2:1) (2.011 g, 1.446 mmol, 95% yield) as an off-white powder. ¹H NMR (500 MHz, DMSO-d₆) δ 9.24 (s, 2H), 8.23-7.75 (m, 18H), 7.57 (d, J=7.9 Hz, 2H), 7.35 (dd, J=55.9, 7.9 Hz, 8H), 6.89-6.72 (m, 4H), 2.09 (s, 24H).

### Example 5—Preparation of Block Copolyimide 6FDA-Durene/6FDA-CARDO(OH) (3:1)

The same procedure as described in Example 3 was followed, using 5,5′-(perfluoropropane-2,2-diyl)bis(isobenzofuran-1,3-dione) (0.574 g, 1.293 mmol) (6FDA), 2,3,5,6-tetramethylbenzene-1,4-diamine (0.250 g, 1.522 mmol) (durene), and m-cresol (12.0 mL), then 5,5′-(perfluoropropane-2,2-diyl)bis(isobenzofuran-1,3-dione) (0.327 g, 0.737 mmol) (6FDA), and 9,9-bis(4-aminophenyl)-9H-fluorene-2,7-diol (0.193 g, 0.507 mmol) [CARDO(OH)], followed by m-cresol (12.00 mL) to afford 6FDA-durene/6FDA-CARDO(OH) (3:1) (1.990 g, 1.431 mmol, 94% yield) as an off-white powder. ¹H NMR (500 MHz, DMSO-d₆) δ 9.22 (s, 2H), 8.18-7.72 (m, 24H), 7.53 (d, J=8.3 Hz, 2H), 7.30 (dd, J=56.0, 8.4 Hz, 8H), 6.83-6.69 (m, 4H), 2.04 (s, 36H).

### Example 6—Preparation of Block Copolyimide 6FDA-DAM/6FDA-CARDO(OH) (3:1)

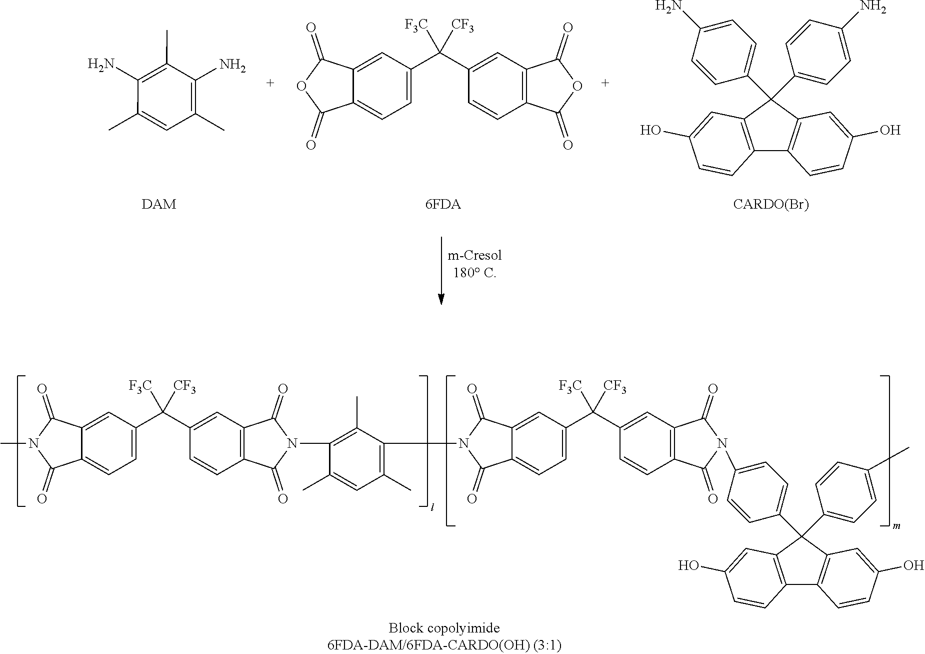

In a 100 mL three-neck round bottom flask equipped with a nitrogen inlet and a magnetic stir bar, 5,5′-(perfluoropropane-2,2-diyl)bis(isobenzofuran-1,3-dione) (0.628 g, 1.414 mmol) (6FDA) and 2,4,6-trimethylbenzene-1,3-diamine (0.250 g, 1.664 mmol) (DAM) were introduced and dissolved in m-cresol (8.00 mL) and the reaction mixture was heated to 180° C. and stirred for 8 hours. The heat was stopped overnight and the reaction was allowed to cool down to room temperature. The reaction mixture was preheated to 160° C., then 5,5′-(perfluoropropane-2,2-diyl)bis(isobenzofuran-1,3-dione) (0.357 g, 0.804 mmol) (6FDA) and 9,9-bis(4-aminophenyl)-9H-fluorene-2,7-diol (0.211 g, 0.554 mmol) [CARDO(OH)] were added, followed by m-cresol (8.00 mL) and the mixture was heated to 180° C. and stirred for 8 hours. The heat was removed and the reaction mixture was allowed to cool down below 100° C., then the resulting highly viscous solution was poured into methanol in thin fibers. The fibrous polymer obtained was ground, rinsed with methanol, filtered and dried under reduced pressure for 24 h at 60° C. to afford 6FDA-DAM/6FDA-CARDO(OH) (3:1) (1.465 g, 1.064 mmol, 96% yield) as an off-white powder. ¹H NMR (500 MHz, DMSO-d₆) δ 9.24 (s, 2H), 8.20-7.76 (m, 24H), 7.57 (d, J=7.6 Hz, 2H), 7.46-7.25 (m, 11H), 6.90-6.72 (m, 4H), 2.15 (s, 18H), 1.92 (s, 9H).

### Example 7—Chemical Characterization

The chemical structures and purity of the compounds described in Examples 1-6 were confirmed using proton nuclear magnetic spectroscopy (¹H NMR) in corresponding deuterated solvents (i.e., DMSO-d₆).

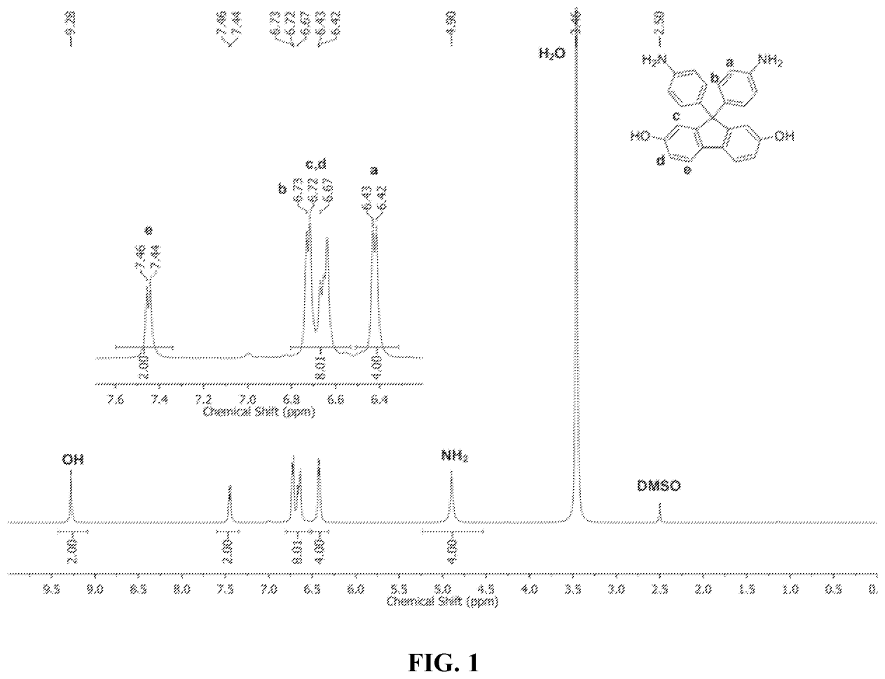

The chemical structure of the CARDO(OH) monomer was confirmed by its ¹H NMR spectrum in deuterated DMSO-d₆ as illustrated in FIG. 1. The spectrum depicts the singlet peak for the hydroxyl groups at 9.28 ppm, and the different aromatic protons that range between 7.46-6.42 ppm, in addition to the primary amine protons represented as a singlet peak at 4.90 ppm. The absence of any other peaks in the spectrum (other than those from the deuterated solvent: H₂O at 3.46 ppm, and DMSO at 2.50 ppm) indicate the high purity of the prepared monomer.

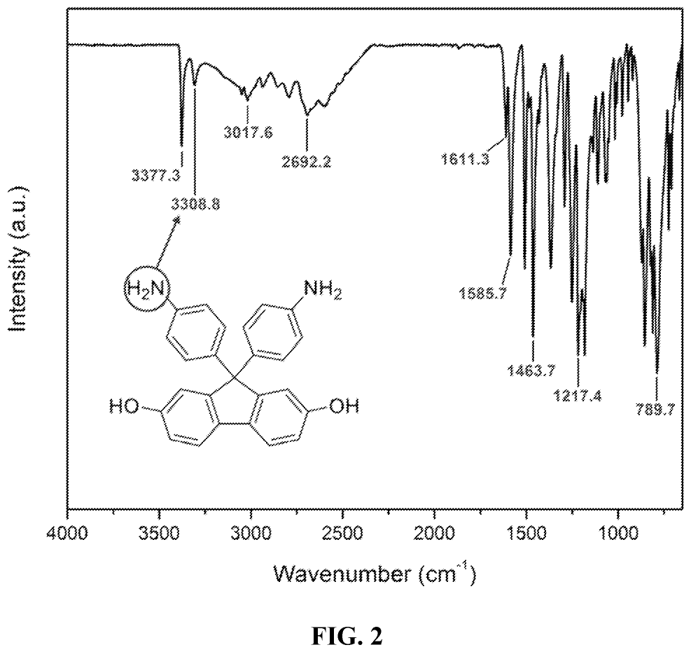

The presence of functional groups within the structure of CARDO(OH) monomer, such as the primary amine groups, were confirmed using Fourier Transform Infrared (FTIR) spectroscopy, and the spectrum is illustrated in FIG. 2. For example, the primary amine stretching bands (N—H) are depicted between 3377 and 3308 cm⁻¹, while the peak at 1611 cm⁻¹ can be assigned to the primary amine N—H bending. Moreover, the peak at 1463 cm⁻¹ is attributed to the aromatic carbon-hydrogen bond (sp 2 C—H) bending.

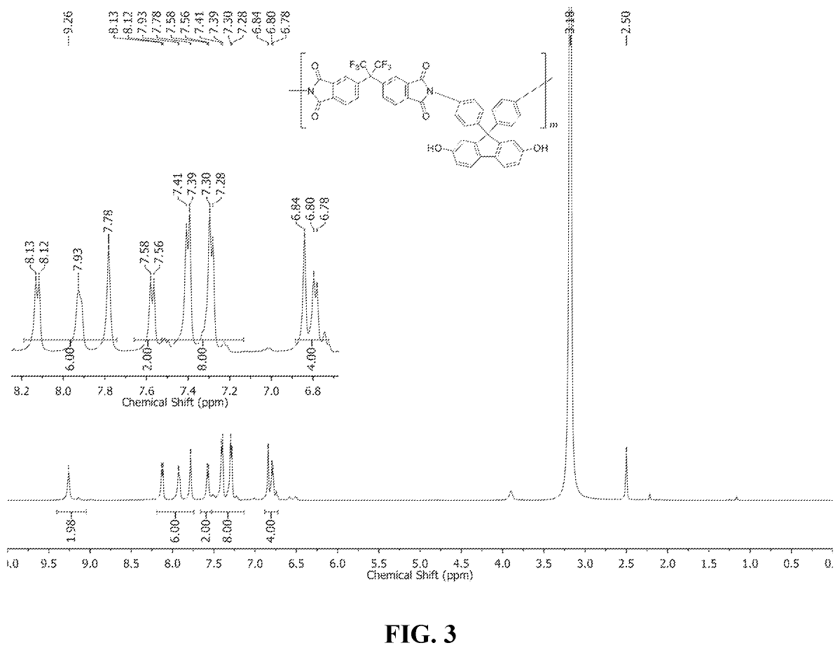

In a similar fashion, the chemical structures and purity of the final product of the polymers described in Examples 1-6 were confirmed using ¹H-NMR in DMSO-d₆. For example, the ¹H-NMR of the homopolymer 6FDA-CARDO(OH) was measured in DMSO-d₆ and it is depicted in FIG. 3. The peak at 9.26 ppm (singlet) is attributed to the hydroxyl groups in CARDO(OH). The peaks at 8.13 ppm (doublet), 7.93 ppm (singlet), and 7.78 ppm (doublet) from the spectrum are attributed to the aromatic protons of 6FDA moiety, while the remaining peaks at 7.56 ppm (doublet), 7.41-7.28 ppm (AB system), the singlet at 6.84, and a doublet at 6.80 ppm are attributed to the CARDO(OH) aromatic protons. The absence of any undesired peaks within the spectrum is an indication of the good purity of the prepared polymer.

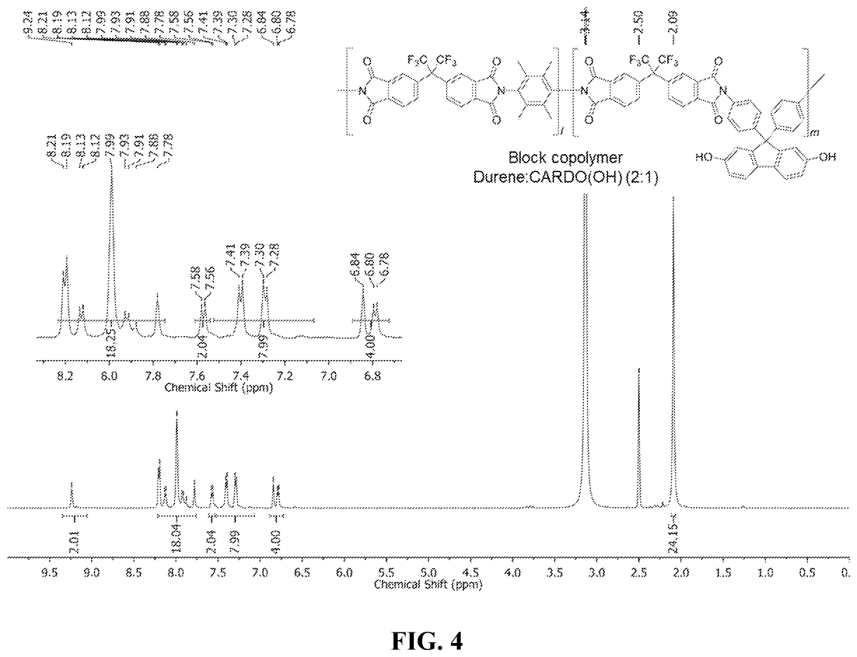

For the copolyimides of Examples 3-6, in addition to determining their chemical structures and purities, the ¹H NMR spectra were further used to determine the molecular ratio of the co-monomers within the copolymer backbone. For example, the desired molar ratio between the co-monomers durene and CARDO(OH) in the 6FDA-durene/6FDA-CARDO(OH) (2:1) block copolymer described in Example 4 is calculated from the area integration of the aromatic peaks of CARDO(OH) and aliphatic peak of durene, from the spectrum illustrated in FIG. 4.

For instance, the durene monomer does not have aromatic protons; however, it possesses 12 aliphatic protons, which appear as a singlet at 2.09 ppm, that correspond to its four methyl groups. If the total integration of the aromatic peaks that correspond to CARDO(OH) are set for a total of 14 protons that correspond to one CARDO(OH) molecule, the singlet peak at 2.09 ppm for durene integrates for 24 protons, which indicates a molar ratio of 2:1 between durene and CARDO(OH) co-monomers.

In a similar way, the molar ratios between durene and CARDO(OH) comonomers in 6FDA-durene/6FDA-CARDO(OH) (1:1) and 6FDA-durene/6FDA-CARDO(OH) (3:1) block copolymers (Examples 3 and 5, respectively), and DAM and CARDO(OH) in 6FDA-DAM/6FDA-CARDO(OH) (3:1) block copolymer (Example 6) were determined using their corresponding ¹H NMR spectra.

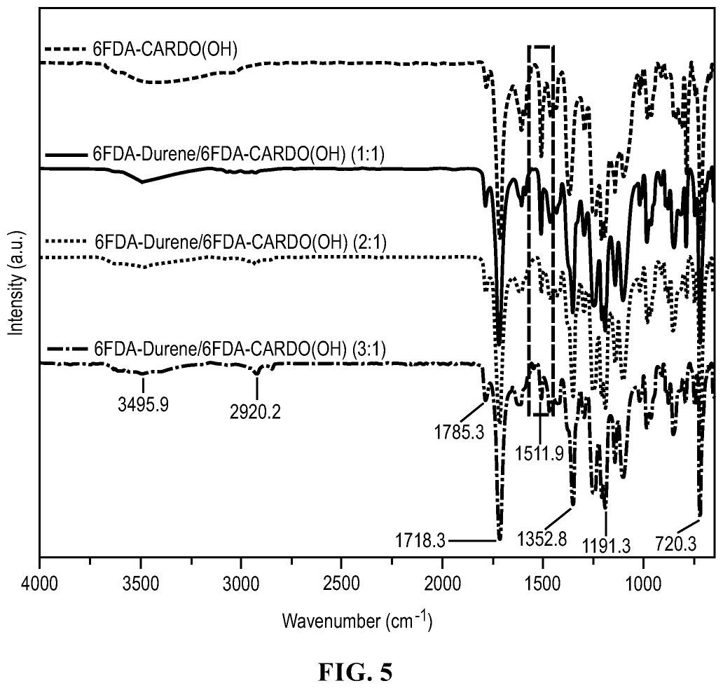

The FTIR spectra of all the described polymers were recorded to ensure that the polycondensation reaction was complete (FIG. 5). In general, the absence of any peaks that correspond to the intermediate species the polyamic acid (3500-3100 and 1700-1650 cm⁻¹) demonstrated that the reaction was complete. On the other hand, the symmetric and asymmetric carbonyl groups of the imide ring depicted at 1785 and 1718 cm¹, respectively, confirmed the formation of the imide ring (final product) within the polymer backbone. Another useful aspect of the FTIR spectra was used to confirm, in a qualitative manner, the molecular ratio of comonomers within the copolymer backbone. For example, the peak at 1511 cm⁻¹ is attributed to the aromatic carbon-hydrogen bond (sp 2 C—H) bending that mainly belongs to those of CARDO(OH) monomer, as can be seen from the FTIR spectrum of 6FDA-CARDO(OH) homopolymer. The intensity of the peak at 1511 cm⁻¹ decreased in the FTIR spectra of the copolyimides with the decrease of the CARDO(OH) molar ratio compared to durene [durene:CARDO(OH) from 0.50 in (1:1) to 0.25 in (3:1)]. Finally, the appearance of the peaks at around 2920 cm⁻¹ in the FTIR spectra of the three copolyimides in FIG. 5 were attributed to the aliphatic C—H bonds of the methyl groups in durene, and the band at 3495 cm⁻¹ was attributed to the hydroxyl groups in the polymer backbone.

### Example 8—Thermal and Physical Properties

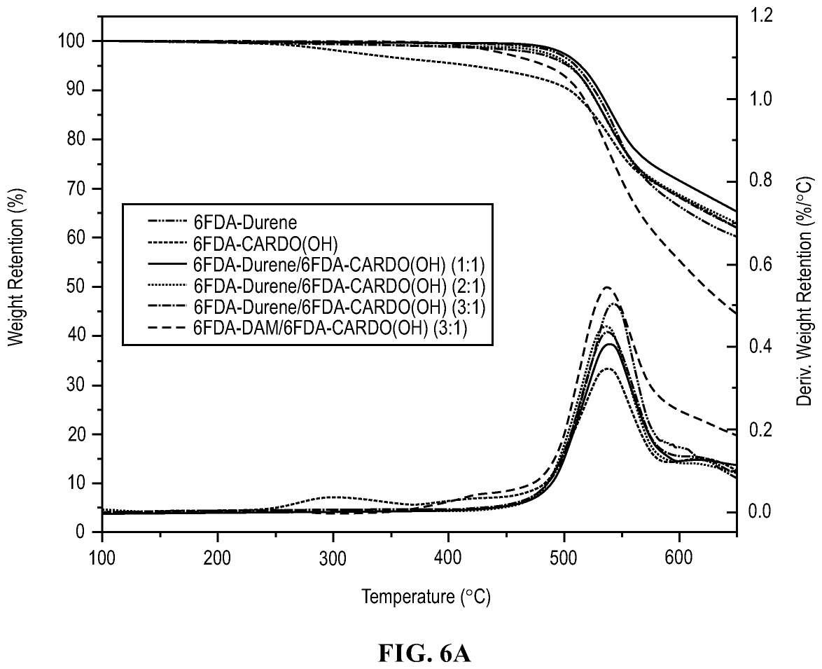

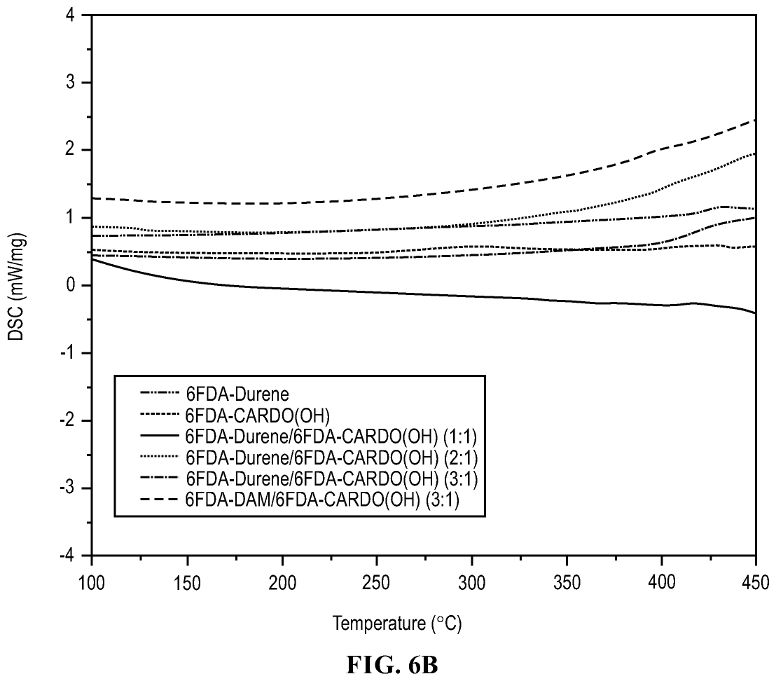

The thermal properties of the prepared polymers were measured using thermal gravimetric analysis (TGA) and differential scanning calorimetry (DSC) and the results are illustrated in FIGS. 6A-6B.

The decomposition temperatures at 5% and 10% were determined (Table) to evaluate the thermal stability of the prepared polymers during the harsh industrial conditions of gas separation application. All T_{d5%} of the prepared copolymers were recorded to be higher than 485° C. which was similar to high thermally stable membranes used in gas separation technology. The first derivatives of the TGA curves (FIG. 6A) were calculated and the values are listed in Table. These values (>530° C.) indicated the highest temperature at which the polymer degraded the fastest, and were additional indication as to the high thermal stability of the prepared polymers.

TABLE 1
Thermal properties of the prepared polymers

| | DSC | TGA | | |
|---|---|---|---|---|
| | T_{g} | T_{d5%} | T_{d10%} | DTG |
| | (° C.) | (° C.) | (° C.) | (° C.) |
| 6FDA-durene | 426 | 510 | 527 | 542 |
| 6FDA-DAM | 395 | 516 | 530 | 545 |
| 6FDA-CARDO(OH) | 401 | 420 | 505 | 535 |
| 6FDA-durene/6FDA-CARDO(OH) (1:1) | 393 | 514 | 530 | 541 |
| 6FDA-durene/6FDA-CARDO(OH) (2:1) | 395 | 505 | 523 | 537 |
| 6FDA-durene/6FDA-CARDO(OH) (3:1) | 419 | 503 | 524 | 538 |
| 6FDA-DAM/6FDA-CARDO(OH) (3:1) | 394 | 485 | 513 | 538 |

The glass transition temperatures (T_{g}) of the polymers described in Examples 1-6 were calculated from their corresponding DSC traces and the values are listed in Table 1. To obtain the T_{g} values, polymer samples were heated for two cycles. The first heating cycle was used to clear the thermal history of the polymer, where the T_{g} was recorded after the second heating cycle. All the recorded T_{g} values were greater than 390° C. These high temperatures indicated the rigidity of the polymeric chains, which could be correlated to their performance during gas separation testing. The values obtained were similar to other glassy polymers used in gas separation technology.

### Example 9—Membrane Preparation

Dense polymeric films of ˜80-100 um thickness were prepared by casting 3 wt % solutions of the prepared polymers in DMF onto flat glass Petri dishes. Beforehand, the solutions were filtered using 0.45 μm PTFE filters to remove undissolved polymer material or impurities. The casted solutions were placed on a leveled surface in an oven preheated to 85° C. under a gentle nitrogen flow for slow solvent evaporation. The membranes obtained were then placed in an oven heated at 200° C. under vacuum. When needed, when the membranes were peeled from the Petri dishes, the membrane samples were soaked in deionized water for a few minutes and then dried at 60° C. in a vacuum oven for 6 hours to remove water.

### Example 10—Pure-Gas Permeation Measurements

The pure-gas permeation properties of membranes prepared from the polymers described in Examples 1-6 were determined using a constant-volume permeation system. For this study, four different single gases were used: He, N₂, CH₄ and CO₂. The permeability coefficients of the polymeric membranes were calculated from the steady state of the pressure versus time curve, using a constant feed pressure of 100 psi and an operating temperature of 22° C. The permeability coefficients are expressed in Barrer [1 Barrer=10⁻¹⁰ cm³(STP)·cm/cm²·s·cmHg]. The ideal selectivity coefficients were calculated by dividing the permeability coefficient of a corresponding gas (He, N₂ or CO₂) by that of methane. The obtained results are listed in Table 2. The pure-gas permeation properties of 6FDA-CARDO(OH) homopolyimide could not be measured, since mechanically stable membranes could not be obtained.

TABLE 2
Pure gas permeability and selectivity coefficients for the polymeric
membranes measured at 100 psi feed pressure and at 22° C.

| | Permeability coefficients (Barrer) | | | | Selectivity coefficients | | |
|---|---|---|---|---|---|---|---|
| Polyimide | He | N₂ | CH₄ | CO₂ | He/CH4 | N₂/CH₄ | CO₂/CH₄ |
| 6FDA-durene | 451 | 55.9 | 46.1 | 740 | 9.77 | 1.21 | 16.0 |
| 6FDA-DAM | 332 | 35.0 | 24.3 | 541 | 13.7 | 1.44 | 22.3 |
| 6FDA-CARDO | 85.0 | 3.30 | 1.96 | 58.9 | 43.4 | 1.68 | 30.1 |
| 6FDA-CARDO(OH) | — | — | — | — | — | — | — |
| 6FDA-durene/6FDA- | — | — | — | — | — | — | — |
| CARDO(OH) (1:1) | | | | | | | |
| 6FDA-durene/6FDA- | 236 | 12.5 | 8.67 | 207 | 27.2 | 1.45 | 23.9 |
| CARDO(OH) (2:1) | | | | | | | |
| 6FDA-durene/6FDA- | 301 | 23.2 | 16.4 | 320 | 18.4 | 1.42 | 19.6 |
| CARDO(OH) (3:1) | | | | | | | |
| 6FDA-DAM/6FDA- | 262 | 13.3 | 8.54 | 233 | 30.7 | 1.56 | 27.3 |
| CARDO(OH) (3:1) | | | | | | | |

Copolymerization methodology is one of the methods employed to improve membranes mechanical properties and their gas permeation through the selection of comonomers that possess desired properties. Durene (2,3,5,6-tetramethylbenzene-1,4-diamine) and DAM (2,4,6-trimethylbenzene-1,3-diamine) are two potential comonomers known for forming membranes with good mechanical and gas permeation properties. Thus, a series of copolyimides containing durene:CARDO(OH) with various molar ratios 1:1, 2:1, and 3:1, and a DAM:CARDO(OH) molar ratio of 3:1 were prepared. These copolyimides formed mechanically stable membranes, with the exception of 6FDA-durene/6FDA-CARDO(OH) (1:1). The pure-gas permeation properties of formed membranes were measured and the results are listed in Table 2.

As part of the molecular design of new polymeric materials, the durene moiety was replaced by a DAM moiety, with a DAM:CARDO(OH) molar ratio equal to 3:1 to form the 6FDA-DAM/6FDA-CARDO(OH) (3:1) block copolyimide. This polymer afforded a membrane with 39% higher CO₂/CH₄ selectivity coefficient than its equivalent 6FDA-durene/6FDA-CARDO(OH) (3:1) with ˜27% lower permeability coefficient.

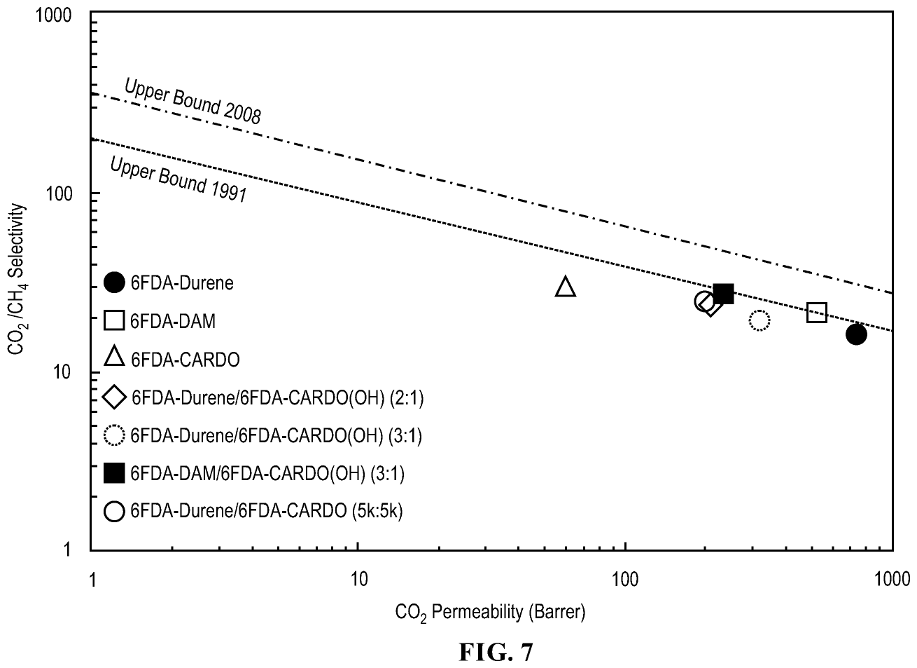

In general, membranes prepared from glassy polymers suffer from a permeability-selectivity trade-off relationship (FIG. 7). For example, the CO₂/CH₄ selectivity decreased from 27.3 for 6FDA-DAM/6FDA-CARDO(OH) (3:1) to 19.6 for 6FDA-durene/6FDA-CARDO(OH) (3:1), while the CO₂ permeability increased from 233 Barrer to 320 Barrer, respectively. Interestingly, the gas permeation properties of the CARDO(OH)-containing polymeric membranes afforded permeability and selectivity coefficients in the commercially favored range.

To better understand the separation process through the prepared membranes, the CO₂ and CH₄ diffusivity coefficients (in cm²/s) were measured using the “time-lag” method. The obtained results are listed in Table 3.

TABLE 3
CO₂ and CH₄ diffusivity coefficients of
prepared polymers at 100 psi and 22° C.

| | Diffusivity | | Diffusivity |
|---|---|---|---|
| | (cm²/s) × 10⁻⁸ | | Selectivity |
| Polymer | CH₄ | CO₂ | CO₂/CH₄ |
| 6FDA-durene | 7.24 | 33.3 | 4.60 |
| 6FDA-DAM | 4.98 | 25.3 | 5.08 |
| 6FDA-CARDO | 0.801 | 5.27 | 6.58 |
| 6FDA-CARDO(OH) | — | — | — |
| 6FDA-durene/6FDA-CARDO(OH) (1:1) | — | — | — |
| 6FDA-durene/6FDA-CARDO(OH) (2:1) | 1.46 | 9.92 | 6.79 |
| 6FDA-durene/6FDA-CARDO(OH) (3:1) | 3.54 | 14.8 | 4.18 |
| 6FDA-DAM/6FDA-CARDO(OH) (3:1) | 6.28 | 12.7 | 2.02 |

The diffusivity coefficients for both CO₂ and CH₄ for the series of durene:CARDO(OH) copolyimides increased with higher durene molar ratio within the copolymer backbones.

Since the permeability coefficient (P) is calculated from the product of diffusivity (D) and solubility (S) coefficients, the solubility coefficients of the prepared polymers were calculated using the following equation:

$$S = \frac{P}{D}$$

The obtained solubility coefficients [in cm³(STP)/cm³·cmHg] are listed in Table 4.

TABLE 4
CO₂ and CH₄ solubility coefficients of
prepared polymers at 100 psi and 22° C.

| | Solubility | | |
|---|---|---|---|
| | (cm³(STP)/ | | |
| | cm³cmHg) × | | Solubility |
| | 10⁻² | | Selectivity |
| Polymer | CH₄ | CO₂ | CO₂/CH₄ |
| 6FDA-durene | 6.24 | 22.1 | 3.54 |
| 6FDA-DAM | 4.48 | 20.7 | 4.62 |
| 6FDA-CARDO | 2.45 | 11.2 | 4.52 |
| 6FDA-CARDO(OH) | — | — | — |
| 6FDA-durene/6FDA-CARDO(OH) (1:1) | — | — | — |
| 6FDA-durene/6FDA-CARDO(OH) (2:1) | 5.94 | 20.9 | 3.52 |
| 6FDA-durene/6FDA-CARDO(OH) (3:1) | 4.63 | 21.6 | 4.67 |
| 6FDA-DAM/6FDA-CARDO(OH) (3:1) | 1.36 | 18.5 | 13.6 |

The CO₂/CH₄ diffusivity and solubility selectivity coefficients were calculated and the results are listed in Table 3 and Table 4, respectively. The CO₂/CH₄ diffusivity selectivity coefficients of the durene:CARDO(OH) copolyimides were in the range of 4.18-6.79, while the CO₂/CH₄ solubility selectivity coefficients were between 3.52-4.67, indicating that the separation through these polymeric membranes was equally solubility and diffusivity driven.

Similarly, the CO₂/CH₄ diffusivity selectivity coefficient of 6FDA-DAM/6FDA-CARDO(OH) (3:1) equaled 2.02, while the CO₂/CH₄ solubility selectivity coefficient was found to be 13.6, indicating that the separation through this polymeric membrane was solubility driven.

### Example 11—Sweet Mixed-Gas Permeation Measurements

Since natural gas is a mixture of different gases, the mixed-gas separation performance of the polymeric membranes was evaluated. For that, the mixed-gas separation performance of the described polymers in Examples 1-6 were measured using a sweet gas mixture containing 10, 59, 30 and 1 vol % of CO₂, CH₄, N₂ and C₂H₆, respectively. The permeation measurements were recorded at different feed pressures (500-900 psi) with an increment of 200 psi at a fixed temperature of 22° C. The obtained results are listed in Table 5.

TABLE 5
Sweet mixed-gas permeability and selectivity coefficients
of studied polymers at various feed pressures and 22° C.

| | P | Permeability coefficients (Barrer) | | | | Selectivity coefficients | | |
|---|---|---|---|---|---|---|---|---|
| Polymer | (psi) | N₂ | CH₄ | C₂H₆ | CO₂ | N₂/CH₄ | C₂H₆/CH₄ | CO₂/CH₄ |
| 6FDA-durene/ | 500 | 3.12 | 4.23 | 3.01 | 146 | 0.738 | 0.712 | 34.4 |
| 6FDA-CARDO(OH) | 700 | 3.36 | 4.01 | 3.73 | 126 | 0.838 | 0.931 | 31.3 |
| (2:1) | 900 | 3.22 | 3.83 | 3.62 | 116 | 0.841 | 0.945 | 30.4 |
| 6FDA-durene/ | 500 | 4.63 | 6.28 | 4.30 | 209 | 0.737 | 0.685 | 33.3 |
| 6FDA-CARDO(OH) | 700 | 3.71 | 5.90 | 5.50 | 185 | 0.629 | 0.932 | 31.4 |
| (3:1) | 900 | 3.55 | 5.53 | 5.40 | 164 | 0.642 | 0.976 | 29.7 |
| 6FDA-DAM/ | 500 | 3.19 | 3.68 | 2.44 | 151 | 0.867 | 0.663 | 41.0 |
| 6FDA-CARDO(OH) | 700 | 2.92 | 3.41 | 2.66 | 131 | 0.856 | 0.780 | 38.4 |
| (3:1) | 900 | 2.73 | 3.23 | 2.00 | 114 | 0.845 | 0.619 | 35.3 |

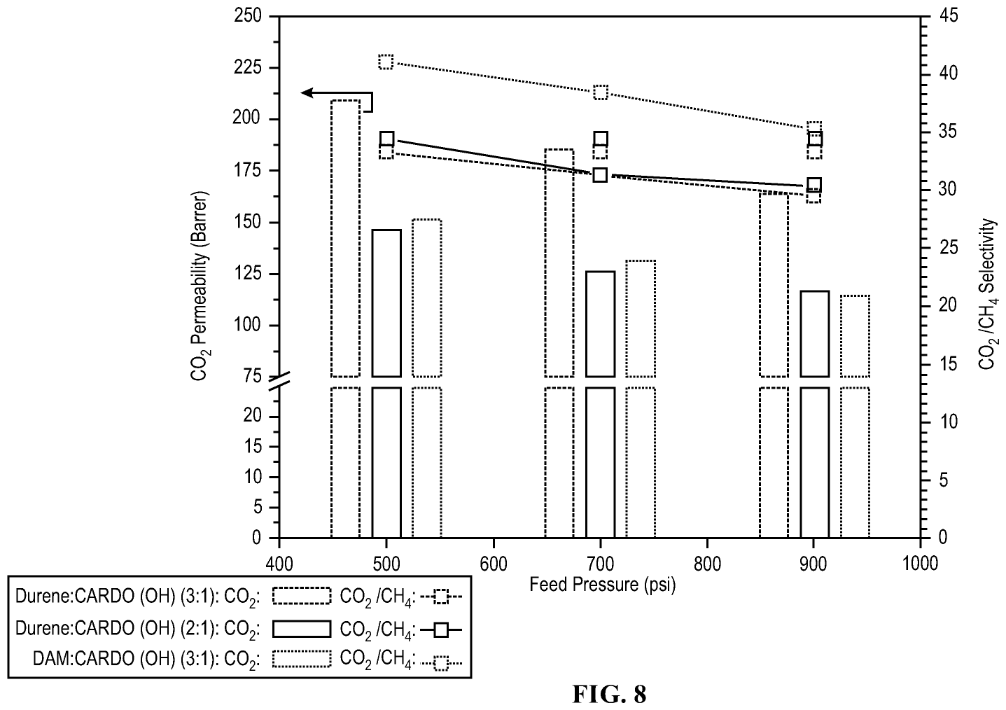

For the durene:CARDO(OH) copolyimide series, the mixed-gas CO₂-permeability coefficients along with their corresponding mixed-gas CO₂/CH₄ selectivity coefficients at the various feed pressures studied are illustrated in FIG. 8. It was observed that the CO₂ permeability coefficients tended to decrease with the increase on the feed pressure (from 500 to 900 psi). For example, the mixed-gas CO₂ permeability coefficient of 6FDA-durene/6FDA-CARDO(OH) (3:1) decreased by ˜22% when the feed pressure increased from 500 psi to 900 psi. In a similar fashion, the CO₂ permeability coefficient of 6FDA-durene/6FDA-CARDO(OH) (2:1) decreased by ˜21%. This change on mixed-gas CO₂ permeability coefficients was attributed to the competition on Langmuir sorption sites between CO₂ and the other existing gases in the mixture (N₂, CH_{4,} and C₂H₆).

As a result of the decrease on the mixed-gas CO₂ permeability coefficients with slight changes on mixed-gas CH₄ permeability coefficients, the CO₂/CH₄ selectivity coefficients decreased when the pressure increased from 500 to 900 psi for all copolyimides (FIG. 8). It is worth mentioning that the mixed-gas CO₂/CH₄ selectivity showed a clear independence of the overall molar ratio of comonomers. For example, for the copolyimides with durene:CARDO(OH) of 2:1 and 3:1, the CO₂/CH₄ selectivity coefficients appear to be the same.

These results of permeability and selectivity at such elevated feed pressures and for such a multicomponent gas mixture, make the durene:CARDO(OH) series of copolyimides very attractive potential materials for industrial natural gas sweetening applications.

Moreover, membranes prepared from 6FDA-DAM/6FDA-CARDO(OH) (3:1) were studied in a similar fashion to that of durene/CARDO(OH) series using the same gas mixture composition and same testing conditions of pressure and temperature. The obtained data are listed in Table 5 and FIG. 12.

As can be seen from FIG. 12, the mixed-gas CO₂ permeability coefficient decreased by ˜25% with an increase on feed pressure from 500 psi to 900 psi. The decrease on the CO₂ permeability coefficients was attributed to the competition on Langmuir sorption sites between CO₂ and the other existing gases in the mixture.

The corresponding CO₂/CH₄ selectivity coefficients of 6FDA-DAM/6FDA-CARDO(OH) (3:1) illustrated in FIG. 12 at various feed pressures depicted a decrease of ˜14% in their values with an increase on the feed pressure from 500 psi to 900 psi. This change was attributed to the prominent change on CO₂ permeability coefficients with slight change on the CH₄ permeability.

Finally, the sweet mixed-gas separation performances at 900 psi of 6FDA-durene/6FDA-CARDO(OH) (3:1) and 6FDA-DAM/6FDA-CARDO(OH) (3:1) copolyimides membranes were used to study the effect of comonomer type on the CARDO(OH)-containing copolyimide. As can be seen from FIG. 12, the 6FDA-durene/6FDA-CARDO(OH) (3:1) copolyimide membrane possessed a higher mixed-gas CO₂ permeability (164 Barrer) than that of 6FDA-DAM/6FDA-CARDO(OH) (3:1) (114 Barrer). However, due to the permeability-selectivity trade-off relationship, the mixed-gas CO₂/CH₄ selectivity of 6FDA-DAM/6FDA-CARDO(OH) (3:1) was ˜16% higher than that of 6FDA-durene/6FDA-CARDO(OH) (3:1). Finally, it is important to note that all disclosed polymeric membranes were resistant to plasticization or swelling at elevated feed pressures, such as 900 psi.

### Example 12—Thermal Crosslinking

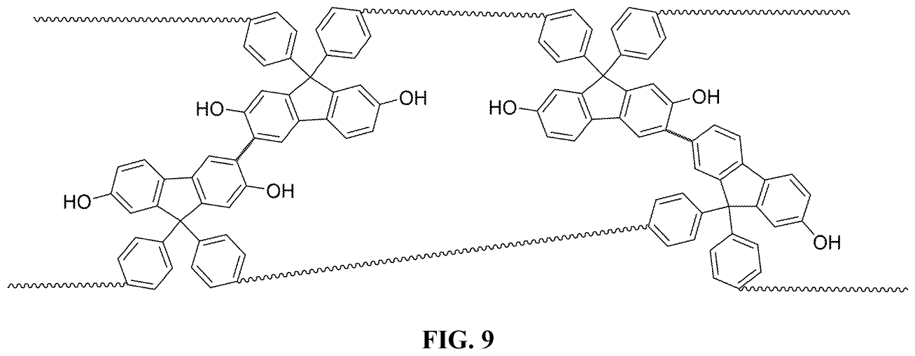

An important aspect of the hydroxyl-functionalized CARDO-based polymers is that they are capable of self-crosslinking at high temperatures (greater than about 180° C.) during the drying process of the membranes. This crosslinking was observed through a change in coloration of the membrane (from light yellow to dark red-brown) and the fact that the solubility of the membranes became very low in the same solvent used to prepare them in the first place. The proposed self-crosslinking mechanism is illustrated in FIG. 9.

This self-crosslinking is considered very advantageous since it improves the mechanical properties of the membrane and more importantly it improves the plasticization resistance at elevated feed pressures, which is very important during sour mixed-gas separation.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A polymer comprising:
a structural repeat unit of Formula (I): 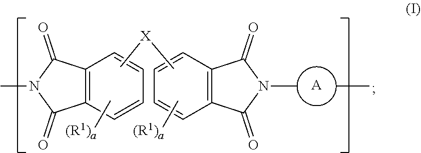
and
a structural repeat unit of Formula (II): 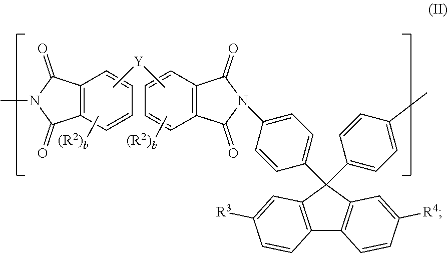
wherein:
A is absent or selected from phenylene, biphenylene, terphenylene, and polycyclic aromatic hydrocarbon, wherein the phenylene, biphenylene, terphenylene, and polycyclic aromatic hydrocarbon are each optionally substituted with one or more R⁵;
X and Y are each independently selected from a bond, —O—, —C(O)—, —O-phenyl-Z-phenyl-O—, and C₁₋₄ alkylene optionally substituted with one or more R⁶;
Z is C₁₋₄ alkylene optionally substituted with one or more R⁶;
each R¹ and R² is independently selected from halo and C₁₋₄ alkyl optionally substituted with one or more halo;
R³ and R⁴ are each independently selected from H, —OH, halo, C₁₋₆ alkyl, C₁₋₆ haloalkyl, phenyl, —C₁₋₄ alkyl-phenyl, and —NR^{a}R^{b}, wherein R^{a} and R^{b} are each independently selected from H and C₁₋₆ alkyl, and wherein at least one of R³ and R⁴ is —OH;
each R⁵ and R⁶ is independently selected from halo, —OH, —NH₂, —SH, —C(O)OH, —N₃, and C₁₋₄ alkyl optionally substituted with one or more R⁷, wherein each R⁷ is independently selected from halo, —OH, —NH₂, —SH, —C(O)OH, and —N₃; and
a and b are each independently 0, 1, 2, or 3;
wherein the polymer comprises the structural repeat unit of Formula (I) and the structural repeat unit of Formula (II) in a molar ratio of about 5:1 to about 1:5.

2. The polymer of claim 1, wherein A is phenylene optionally substituted with one, two, three, or four R⁵.

3. The polymer of claim 2, wherein each R⁵ is independently C₁₋₄ alkyl.

4. The polymer of claim 3, wherein each R⁵ is methyl.

5. The polymer of claim 1, wherein X and Y are each C₁ alkylene, each optionally substituted with one or two R⁶.

6. The polymer of claim 5, wherein each R⁶ is independently C₁ alkyl optionally substituted with one, two, or three R⁶, and each R⁶ is independently halo.

7. The polymer of claim 1, wherein X and Y are each C₁ alkylene, wherein each C₁ alkylene is substituted with two —CF₃.

8. The polymer of claim 1, wherein R³ and R⁴ are each independently selected from H, —OH, halo, C₁₋₄ alkyl, phenyl, —C₁₋₂ alkyl-phenyl, —NH₂, and —N(CH₃)₂, wherein at least one of R³ and R⁴ is —OH.

9. The polymer of claim 1, wherein R³ is —OH and R⁴ is selected from H, —OH, halo, C₁₋₄ alkyl, phenyl, —C₁₋₂ alkyl-phenyl, —NH₂, and —N(CH₃)₂.

10. The polymer of claim 1, wherein R³ and R⁴ are each —OH.

11. The polymer of claim 1, wherein a and b are each independently 0 or 1.

12. The polymer of claim 1, comprising the structural repeat unit of Formula (I) and the structural repeat unit of Formula (II) in a molar ratio of about 3:1 to about 1:3.

13. The polymer of claim 1, comprising the structural repeat unit of Formula (I) and the structural repeat unit of Formula (II) in a molar ratio of about 2:1 to about 1:2.

14. The polymer of claim 1, comprising the structural repeat unit of Formula (I) and the structural repeat unit of Formula (II) in a molar ratio of about 1:1.

15. The polymer of claim 1, having a number-average molecular weight of about 1,000 g/mol to about 1,000,000 g/mol.

16. The polymer of claim 1, having a number-average molecule weight of about 100,000 g/mol to about 500,000 g/mol.

17. The polymer of claim 1, wherein:
the structural repeat unit of Formula (I) is a structural repeat unit of Formula (I-B): 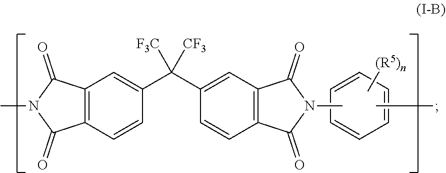
and
the structural repeat unit of Formula (II) is a structural repeat unit of Formula (II-B): 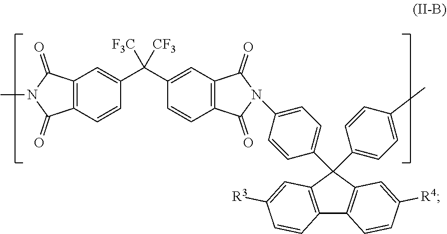
wherein:
R³ and R⁴ are each independently selected from H, —OH, halo, C₁₋₄ alkyl, phenyl, —C₁₋₂ alkyl-phenyl, —NH₂, and —N(CH₃)₂, wherein at least one of R³ and R⁴ is —OH;
each R⁵ is independently C₁₋₄ alkyl;
n is 0, 1, 2, 3, or 4; and
the polymer comprises the structural repeat unit of Formula (I-B) and the structural repeat unit of Formula (II-B) in a molar ratio of about 3:1 to about 1:3.

18. The polymer of claim 17, wherein R³ and R⁴ are each —OH.

19. The polymer of claim 17, wherein each R⁵ is methyl.

20. The polymer of claim 17, wherein n is 3 or 4.

21. The polymer of claim 17, comprising the structural repeat unit of Formula (I-B) and the structural repeat unit of Formula (II-B) in a molar ratio of about 2:1 to about 1:2.

22. The polymer of claim 17, comprising the structural repeat unit of Formula (I-B) and the structural repeat unit of Formula (II-B) in a molar ratio of about 1:1.

23. A membrane comprising the polymer of claim 1.

24. The membrane of claim 23, comprising at least about 80 wt % of the polymer.

25. A method for separating CO₂ and H₂S from natural gas, the method comprising:
introducing a natural gas stream to the membrane of claim 23; and
separating the CO₂ and the H₂S from the natural gas stream.

26. The method of claim 25, wherein the natural gas stream comprises about 1 vol % to about 30 vol % of CO₂ and about 1 vol % to about 40 wt % of H₂S, prior to separating the CO₂ and the H₂S from the natural gas stream.
